(19) United States
(12) Patent Application Publication
(10) Pub. No.: US 2015/0127646 A1
(43) Pub. Date: May 7, 2015

(54) BIG DATA ANALYTICS

(71) Applicant: AT&T Intellectual Property I, L.P., Atlanta, GA (US)

(72) Inventor: Venson M. Shaw, Kirkland, WA (US)

(73) Assignee: AT&T Intellectual Property I, L.P., Atlanta, GA (US)

(21) Appl. No.: 14/069,491

(22) Filed: Nov. 1, 2013

(51) Int. Cl. G06F 17/30

(52) U.S. Cl. CPC G06F 17/30312
USPC 707/737; 707/736

(57) ABSTRACT

Data may be processed based on a type of application, a user, a type of device, a user profile, and/or a device profile. Data may be processed, in real time as it is received. The data may be segmented and/or partitioned into portions. For each portion, a user identifier associated with the portion may be determined. For each portion, an application associated with the portion may be determined. For each portion, a device associated with the portion may be determined. It may be determined whether a portion of the data is to be further processed based on the user identifier, the application, and/or the device. A portion of data that is to be further processed may be prioritized, directed to specific processing, and/or classified. Subsequent procession, and/or storage, of a portion of data may be based a result of at least one of the prioritizing, the directing, and/or the classifying.

### TECHNICAL FIELD

The technical field generally relates to big data, and more specifically relates to prioritizing and processing big data.

### BACKGROUND

The term “big data” often is used to refer to large amounts of complex data. Because of the large volume and high throughput aspects of big data, big data may be difficult to process using traditional data processing mechanisms including database management systems.

### SUMMARY

Data may be differentiated, filtered, directed, classified, and/or prioritized based on a type of application, a user, a type of device, a user profile, and/or a device profile. Processing data in this manner may allow for more efficient processing of large amounts of data at a high throughput rate. In an example embodiment, data may be processed, in real time as it is received. The data may be segmented and/or partitioned into portions. For each portion, a user identifier associated with the portion may be determined. For each portion, an application associated with the portion may be determined. For each portion, a device associated with the portion may be determined. It may be determined whether a portion of the data is to be further processed based on the user identifier, the application, and/or the device. A portion of data that is to be further processed may be prioritized, directed to specific processing, and/or classified. Subsequent procession, and/or storage, of a portion of data may be based a result of at least one of the prioritizing, the directing, and/or the classifying.

### BRIEF DESCRIPTION OF THE DRAWINGS

Aspects of big data analytics are described more fully herein with reference to the accompanying drawings, in which example embodiments are shown. In the following description, for purposes of explanation, numerous specific details are set forth in order to provide an understanding of the various embodiments. However, the instant disclosure may be embodied in many different forms and should not be construed as limited to the example embodiments set forth herein. Like numbers refer to like elements throughout.

FIG. 1 is a diagram of an example system and process for implementing big data analytics.

FIG. 2 is another diagram of an example system and process for implementing big data analytics.

FIG. 3 is a flow diagram of an example process for implementing big data analytics.

FIG. 4 is a flow diagram of an example process for implementing big data analytics.

FIG. 5 is a flow diagram of an example process for implementing big data analytics.

FIG. 6 is a flow diagram of an example process for implementing big data analytics.

FIG. 7 is a flow diagram of an example process for implementing big data analytics.

FIG. 8 is a block diagram of an example device that may be utilized to implement and/or facilitate big data analytics.

FIG. 9 is a block diagram of an example network device (entity) that may be utilized to implement and/or facilitate big data analytics.

FIG. 10 is a diagram of an example communications system in which big data analytics may be implemented.

FIG. 11 is a system diagram of an example WTRU.

FIG. 12 is a system diagram of an example RAN and an example core network.

FIG. 13 depicts an overall block diagram of an example packet-based mobile cellular network environment, such as a GPRS network, within which big data analytics may be implemented.

FIG. 14 illustrates an architecture of a typical GPRS network within which big data analytics may be implemented.

FIG. 15 illustrates an example block diagram view of a GSM/GPRS/IP multimedia network architecture within which big data analytics may be implemented.

FIG. 16 illustrates a PLMN block diagram view of an example architecture in which big data analytics may be implemented.

### DETAILED DESCRIPTION OF ILLUSTRATIVE EMBODIMENTS

As described herein, big data may be intelligently differentiated, filtered, directed, classified, focused, and/or prioritized based on a type of application, a user, a type of device, a user profile, a device profile, or any appropriate combination thereof. Processing data in this manner may allow for more efficient processing of large amounts of data at a high throughput rate. Data may be processed in real time as it is received. The data may be analyzed to determine a user associated with the data, a user identifier associated with the data, an application associated with the data, a device associated with the data, a device identifier associated with the data, a user profile associated with the data, a device profile associated with the data, or any appropriate combination thereof. Each portion of the data may be saved, discarded, and/or passed on for further processing, based on the user associated with the data, the user identifier associated with the data, the application associated with the data, the device associated with the data, the device identifier associated with the data, the user profile associated with the data, the device profile associated with the data, or any appropriate combination thereof.

In an example embodiment, a home subscriber server (HSS) or the like may intelligently analyze data. Data may be analyzed to associate an application, a user, and/or a device identity (e.g., Service ID, IMSI and IMEI) with the data in order to manage and/or regulate mobile big data traffic flow. The application, user profile, and/or device profile may be leveraged to identity and distinguish mobile big data traffic. Data flow may be traversed over a long term evolution (LTE) mobile network. Big data anaylitics as described herein may be utilized to refine a subscriber profile.

In an example embodiment, an HSS, or the like may direct (steer) data based on various factors as described herein. The HSS may prioritize and identify critical mobile big data traffic to identify important applications (e.g., TWITTER, FACEBOOK, etc.), to identify important devices (e.g., IPAD, IPHONE, NOOK, etc.), to identify important customers in order to mitigate any potential detractors to the user experience. Data may be analyzed to provide information to a user, such as a promotion, an advertisement, and/or to monitor performance.

In various example embodiments as described herein, a network (e.g., LTE network, etc.) may collect mobile big data traffic according to an application, user, and/or device identity (e.g., Service ID, IMSI and IMEI). The network may forward the user and/or device aware mobile big data traffic to an HSS analytics engine or the like. The HSS analytics engine may associate the mobile big data traffic with the corresponding user and/or device profile. The HSS analytics engine may classify mobile big data traffic as high priority, medium priority, or low priority based on the corresponding user and/or device profile. The HSS analytics engine may pay special attention to selective top 5-10% tier of the subscribers (most valuable customer), selective bottom 5-10% tier of the customer (potential detractors), and/or selective 5-10% traffic associated with the newly launched high profile devices (e.g., iPHONE 5, IPAD-III, SURFACE PRO 2 etc.). The HSS analytics engine may ignore 90-95% of the mobile big data traffic for average users and/or average devices. The HSS analytics engine may communicate with the network to assign/allocate network resource for the selective group of users and/or devices to ensure highest level of customer satisfaction, quality of service, and user experience.

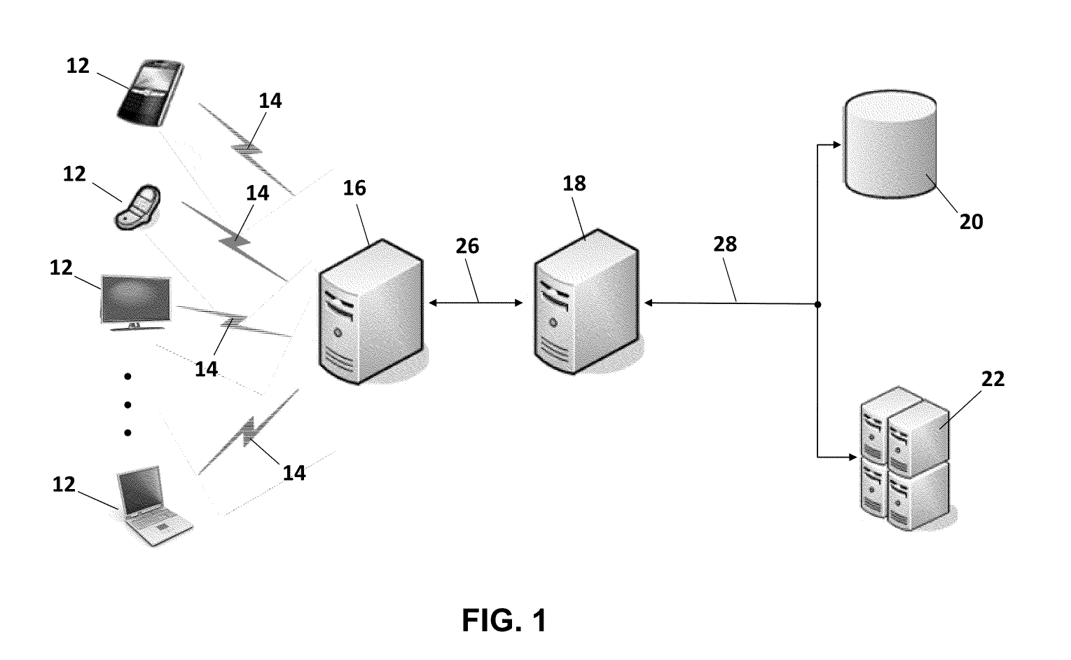

FIG. 1 is a diagram of an example system and process for implementing big data analytics. As depicted in FIG. 1, data may be provided and/or received by devices 12. The devices 12 may represent any appropriate single device or multiple devices that may send and/or receive data. Data may be provided by the devices(s) 12 at step 14. The provided data may be received by a processor 16. The processor 16 may analyze the data, as the data is received, in real time. The processor may analyze any appropriate portion of the data. For example, the processor 16 may segment and/or partition data into portions. The processor 16 may analyze the data or any appropriate portion of the data to determine a user associated with the data or portion of data. The processor 16 may associate a user identifier, also referred to herein as a user ID (e.g., user name, subscriber name, international mobile subscriber identity—IMSI, phone number, email address, registration status, etc.), with the user. The processor 16 may associate a user, a user identifier, or any appropriate combination of user(s) and/or user ID(s) with the data or portion of data.

The processor 16 may analyze the data or any appropriate portion of the data to determine an application (e.g., email, text, voice, video, images, multimedia, instant messaging, streaming media, social media, FACEBOOCK, TWITTER, YOUTUBE, Blogs, video sharing, photo sharing, podcast, professional network, social search, etc.) associated with the data or portion of the data. The processor 16 may associate an application identifier, also referred to herein as an application ID, with the application. The processor 16 may associate an application, an application ID and/or any appropriate combination of application and/or application ID(s) with the data or portion of data.

The processor 16 may analyze the data or any appropriate portion of the data to determine a device (e.g., cellular phone, laptop, tablet, IPHONE, SURFACE, SURFACE PRO, desktop, server, processor, computer, personal digital assistant—PDA, etc.) associated with the data or portion of the data. The processor 16 may associate a device identifier, also referred to herein as an application ID (e.g., international mobile station equipment identity—IMEI, serial number, device type code, etc.), with the application. The processor 16 may associate a device, a device ID, or any appropriate combination of device(s) and/or devices ID(s) with the data or portion of data.

The processor 16 may provide data to a processor 18 at step 26. The data received by processor 18 may comprise data as received by processor 16, the data received by processor 18 may comprise associated information as described above, or any appropriate combination thereof. For example, data received by processor 18 may be portioned/segmented/partitioned (e.g., packets) wherein each portion has associated therewith a user, a user ID, an application, an application ID, a device, a device ID, or any appropriate combination thereof. In an example embodiment, data received by processor 18 may not be partitioned/segmented/portioned, and may comprise associated information inserted at appropriate locations in the data. For example, data received by processor 18 may comprise a user, a user ID, an application, an application ID, a device, a device ID, or any appropriate combination thereof, inserted into the data at appropriate location(s).

The processor 18 may prioritize data received at step 26. The processor 18 may prioritize data based on a user, a user identifier, an application, an application ID, a device, a device ID, a registration status of a user, a registration status of a device, a current location of a device, a current location of a user, a current time, a quality of service (QoS), an access point name (APN) being utilized, a user profile, a user preference, a device profile, a device preference, or any appropriate combination thereof. Based on priority, data may be discarded, data may be stored (for example in database 20), data may further processed (for example by processor 22), or any appropriate combination thereof. For example, based on priority, some data may be determined to be not useful or irrelevant. The not useful/irrelevant data may be discarded. Based on priority, some data may be determined to be relevant, but may not require processing at the current time. This data may be stored (archived) for subsequent processing. Based on priority, some data may be determined to be more valuable than other data. The more valuable data may be processed by processor 22. Upon processing by processor 22, results of the processed data may be provided to respective devices 12.

In an example embodiment, data may be processed, by processor 22, in sequential order based on priority. For example, portions of data having higher priority may be processed before portions of data having a lower priority. Or, portions of data having higher priority may be placed closer to the head of a processing queue than data having a lower priority.

It is to be understood that FIG. 1 is exemplary and not limiting to structure or function. For example, processor 16, processor 18, database 20, and processor 22 may be implemented in any appropriate structure or manner. Processor 16, processor 18, database 20, and processor 22 may be implemented as a single entity (e.g., processor) or as any appropriate number of entities. The functionality of processor 16, processor 18, database 20, and processor 22 as described above is exemplary and not to be constructed as limited thereto. For example, the functionality, as described above, of processor 16, processor 18, database 20, and processor 22 may be performed by any appropriate one and/or combination of processor 16, processor 18, database 20, and processor 22.

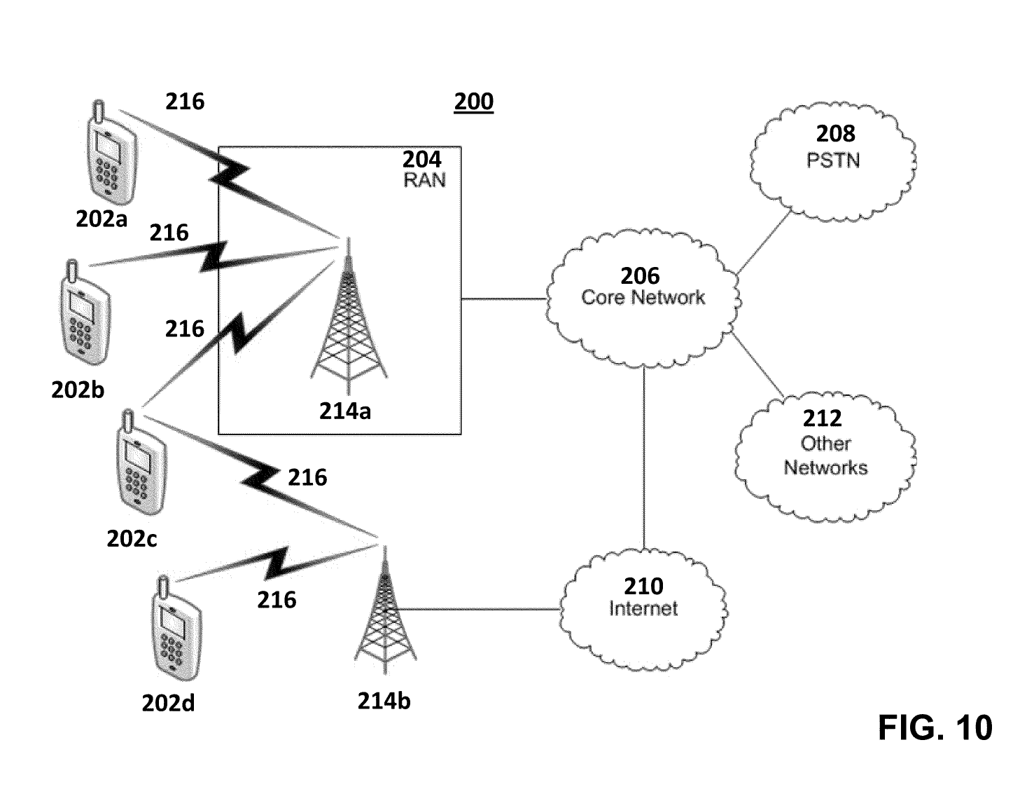

The processors and database depicted in FIG. 1 may comprise any appropriate entity or combination of entities as depicted in FIG. 10 through FIG. 16. In an example embodiment, processor 16 may comprise a home subscriber server (HSS) or the like. In an example embodiment, processor 18 may comprise a home subscriber server (HSS) or the like. In an example embodiment, database 20 may comprise a home subscriber server (HSS) or the like. In an example embodiment, processor 22 may comprise a home subscriber server (HSS) or the like.

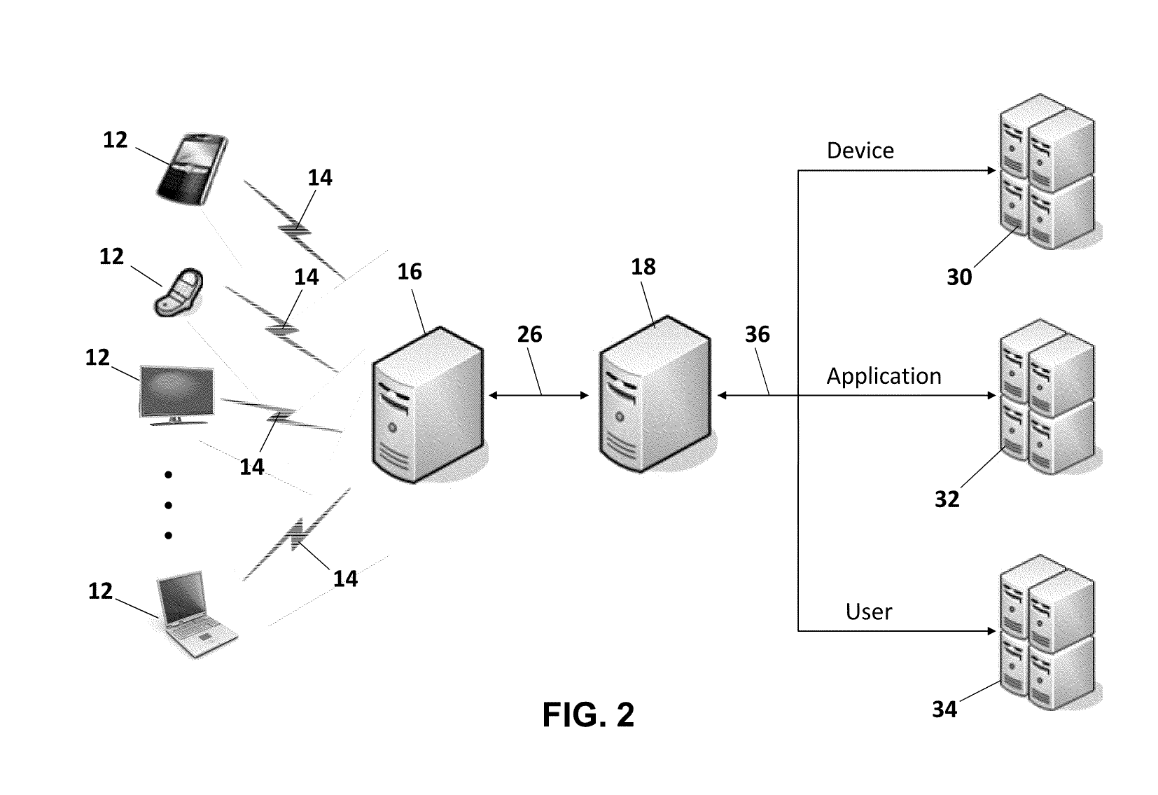

FIG. 2 is another diagram of an example system and process for implementing big data analytics. Elements 12, 16, and 18, and steps 14 and 26 depicted in FIG. 2 correspond, respectively, to elements 12, 16, and 18, and steps 14 and 26 depicted in FIG. 1. As depicted in FIG. 2, processor 18 may classify data received at step 26 as being associated with various entities and/or functions. In an example embodiment, as depicted in FIG. 2, processor 18 may classify data as being associated with a device, an application, a user, or any appropriate combination thereof.

As depicted in FIG. 2, the processor 18 may direct (steer) data received at step 26 to various processing functions based on the content of the data and/or information associated with the data. For example, the processor 18 may direct data, at step 36, based on a user, a user identifier, an application, an application ID, a device, a device ID, a registration status of a user, a registration status of a device, a current location of a device, a current location of a user, a current time, a quality of service (QoS), an access point name (APN) being utilized, a user profile, a user preference, a device profile, a device preference, or any appropriate combination thereof. Based on content and/or associated information, data may be discarded, data may be stored (for example in database 20), data may further processed (for example by processor 22), or any appropriate combination thereof. For example, based on content and/or associated information, some data may be determined to be not useful or irrelevant. The not useful/irrelevant data may be discarded. Based on content and/or associated information, some data may be determined to be relevant, but may not require processing at the current time. This data may be stored (archived) for subsequent processing. Based on content and/or associated information, some data may be determined to be more valuable than other data. The more valuable data may be processed by processor 22. Upon processing by processor 22, results of the processed data may be provided to respective devices 12.

In example embodiments, processor 18 may direct data, at step 36, to processor 30 based on a device, processor 18 may direct data, at step 36, to processor 32 based on an application, and/or processor 18 may direct data, at step 36, to processor 34 based on a user, or any appropriate combination thereof. Thus, network resources (e.g., processor 30, processor 32, processor 34, etc.) may be allocated based on content of data and/or information associated with data.

In an example embodiment, as data is received (at step 26) by processor 18, in real time, processor 18 may determine what device and/or device ID is associated with a portion of the data, and based on the determination as to the device or device ID, the processor may provide data associated therewith to processor 30 for further processing. The determination as to what data to provide to processor 30 may be based on, for example, a current time, a location of a device, a user profile, a device profile, a priority of a device, a priority of a device ID, or the like, or any appropriate combination thereof. For example, a user profile may indicate that smart phone and tablet devices are key (valuable, high priority, etc.) devices. Thus data received from the user's smart phone and/or tablet device are to be processed. And, in this example scenario, processor 18 may provide, at step 36, smart phone and tablet device data to processor 30. In an example embodiment, data associated with a device may be prioritized by processor 18. In an example embodiment, data may be prioritized based on a current time and/or a current location. For example, a user profile may indicate that more current data are to have a higher priority than older data. Thus, in this example scenario, for data associated with a device, processor 18 may determine a time when data was received from the device and prioritize the data, wherein data received closest to the current time may be provided to processor 30 before data received at later times.

In another example embodiment, a user profile may indicate that data received at a specific time of day, specific times of day, and/or a specific period of time are to have a higher priority than data received at other times. For example, data received during a work day (e.g., between 9:00 AM and 6:00 PM) may be indicated as having a high priority. Thus, in this example scenario, for data associated with a device, processor 18 may determine a time when data was received from the device and prioritize the data, wherein data received during the predetermined period of time may be provided to processor 30 before data received at other times.

In another example embodiment, a user profile may indicate that data received from a specific location, or specific locations, are to have higher priority that data received from other locations. Thus, in this example scenario, for data associated with a device, processor 18 may determine a location from which the data was received, wherein data received from the predetermined location, or locations, may be provided to processor 30 before data received from other locations.

In an example embodiment, as data is received (at step 26) by processor 18, in real time, processor 18 may determine what application is associated with a portion of the data, and based on the determination as to the application, the processor may provide data associated therewith to processor 32 for further processing. The determination as to what data to provide to processor 32 may be based on, for example, a current time, a location of a device, a user profile, a device profile, a priority of an application, or the like, or any appropriate combination thereof. For example, a user profile may indicate that social media applications (e.g., TWITTER, FACEBOOK, etc.) are key (valuable, high priority, etc.) applications. Thus data associated with social media are to be processed. And, in this example scenario, processor 18 may provide, at step 36, social media data to processor 32. In an example embodiment, data associated with an application may be prioritized by processor 18. In an example embodiment, data may be prioritized based on a current time and/or a current location. For example, a user profile may indicate that more current data are to have a higher priority than older data. Thus, in this example scenario, for data associated with an application, processor 18 may determine a time when social media data was received and prioritize the data, wherein data received closest to the current time may be provided to processor 32 before data received at later times.

In another example embodiment, a user profile may indicate that data received at a specific time of day, specific times of day, and/or a specific period of time are to have a higher priority than data received at other times. For example, data received during a work day (e.g., between 9:00 AM and 6:00 PM) may be indicated as having a high priority. Thus, in this example scenario, for data associated with an application, processor 18 may determine a time when data was received and prioritize the data, wherein data received during the predetermined period of time may be provided to processor 32 before data received at other times.

In another example embodiment, a user profile may indicate that data received from a specific location, or specific locations, are to have higher priority that data received from other locations. Thus, in this example scenario, for data associated with an application, processor 18 may determine a location from which the data was received, wherein data received from the predetermined location, or locations, may be provided to processor 32 before data received from other locations.

In an example embodiment, as data is received (at step 26) by processor 18, in real time, processor 18 may determine what user is associated with a portion of the data, and based on the determination as to the user, the processor may provide data associated therewith to processor 34 for further processing. The determination as to what data to provide to processor 34 may be based on, for example, a current time, a location of a device, a user profile, a device profile, a priority of a user, or the like, or any appropriate combination thereof. For example, specific types of subscriptions (e.g., most valuable customers) may be indicative of key (valuable, high priority, etc.) users. Thus data associated with the specific users are to be processed. And, in this example scenario, processor 18 may provide, at step 36, predetermined user data to processor 34. In an example embodiment, data associated with the predetermined users may be prioritized by processor 18. In an example embodiment, data may be prioritized based on a current time and/or a current location. For example, a user profile may indicate that more current data are to have a higher priority than older data. Thus, in this example scenario, for data associated with a predetermined user, processor 18 may determine a time when data was received and prioritize the data, wherein data received closest to the current time may be provided to processor 34 before data received at later times.

In another example embodiment, a user profile may indicate that data received at a specific time of day, specific times of day, and/or a specific period of time are to have a higher priority than data received at other times. For example, data received during a work day (e.g., between 9:00 AM and 6:00 PM) may be indicated as having a high priority. Thus, in this example scenario, for data associated with a predetermined user, processor 18 may determine a time when data was received and prioritize the data, wherein data received during the predetermined period of time may be provided to processor 34 before data received at other times.

In another example embodiment, a user profile may indicate that data received from a specific location, or specific locations, are to have higher priority that data received from other locations. Thus, in this example scenario, for data associated with a predetermined user, processor 18 may determine a location from which the data was received, wherein data received from the predetermined location, or locations, may be provided to processor 34 before data received from other locations.

It is to be understood that although processor 30, processor 32, and processor 34 are depicted in FIG. 2 as separate entities, the depicted structure and functionality are not to be construed as limited thereto. In various example embodiments, the functions performed by processor 30, processor 32, and processor 34 may be performed by a single entity or any appropriate number and/or configuration of entities.

The processors depicted in FIG. 2 may comprise any appropriate entity or combination of entities as depicted in FIG. 10 through FIG. 16. In an example embodiment, processor 16 may comprise a home subscriber server (HSS) or the like. In an example embodiment, processor 18 may comprise a home subscriber server (HSS) or the like. In an example embodiment, processor 30 may comprise a home subscriber server (HSS) or the like. In an example embodiment, processor 32 may comprise a home subscriber server (HSS) or the like. In an example embodiment, processor 34 may comprise a home subscriber server (HSS) or the like.

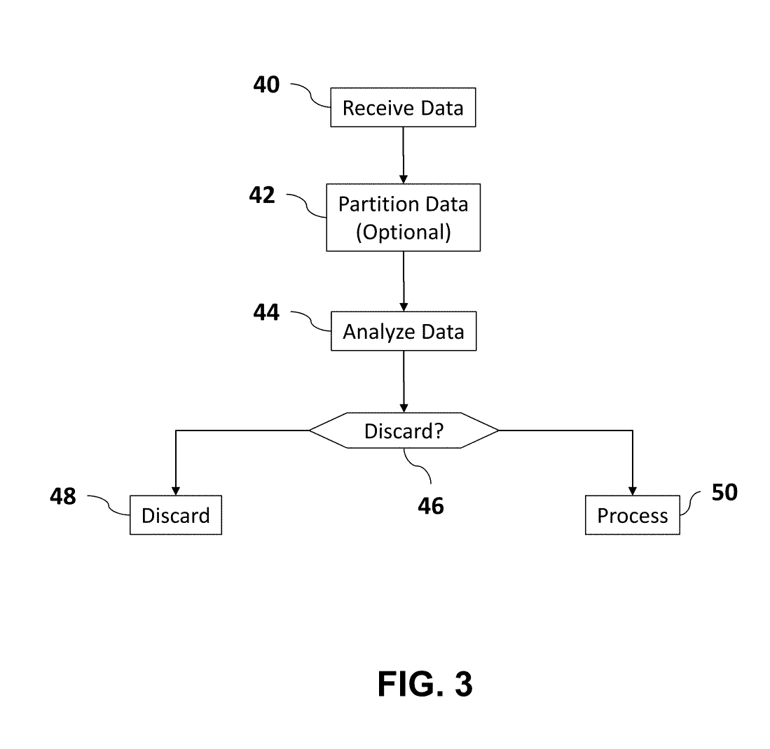

FIG. 3 is a flow diagram of an example process for implementing big data analytics. Data may be received at step 40. Data optionally may be partitioned, as described above, at step 42. Data, or portion thereof, may be analyzed, as described above, at step 44. At step 46 it may be determined if data, or portion thereof, is to be discarded based on the analysis performed at step 44. If it is determined at step 46 that data, or portion thereof, is to be discarded, the data, or portion thereof, may be discarded at step 48. If it is determined at step 46 that data, or portion thereof, is not to be discarded, the data, or portion thereof, may be processed, as described above, at step 50.

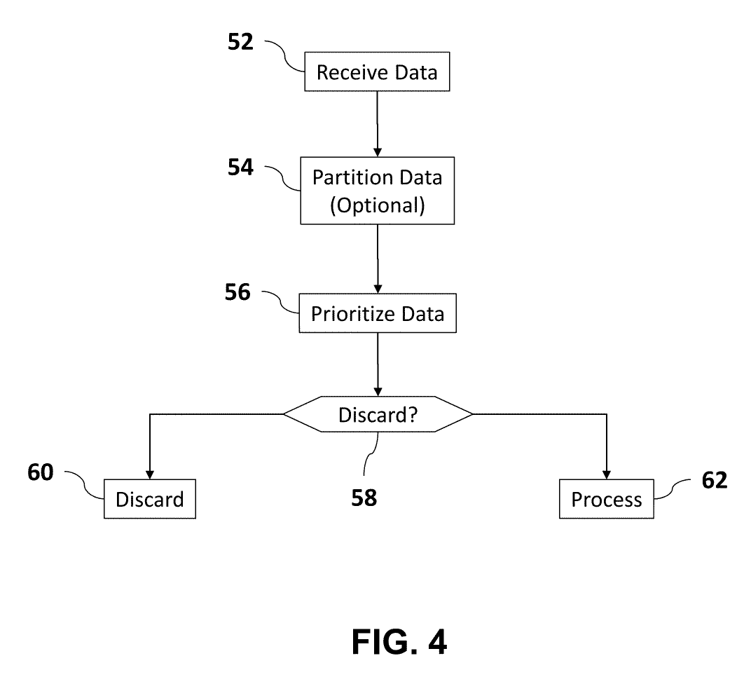

FIG. 4 is another flow diagram of an example process for implementing big data analytics. Data may be received at step 52. Data optionally may be partitioned, as described above, at step 54. Data, or portion thereof, may be prioritized, as described above, at step 56. At step 58 it may be determined if data, or portion thereof, is to be discarded, based on the prioritization performed at step 56. If it is determined at step 58 that data, or portion thereof, is to be discarded, the data, or portion thereof, may be discarded at step 60. If it is determined at step 58 that data, or portion thereof, is not to be discarded, the data, or portion thereof, may be processed, as described above, at step 62.

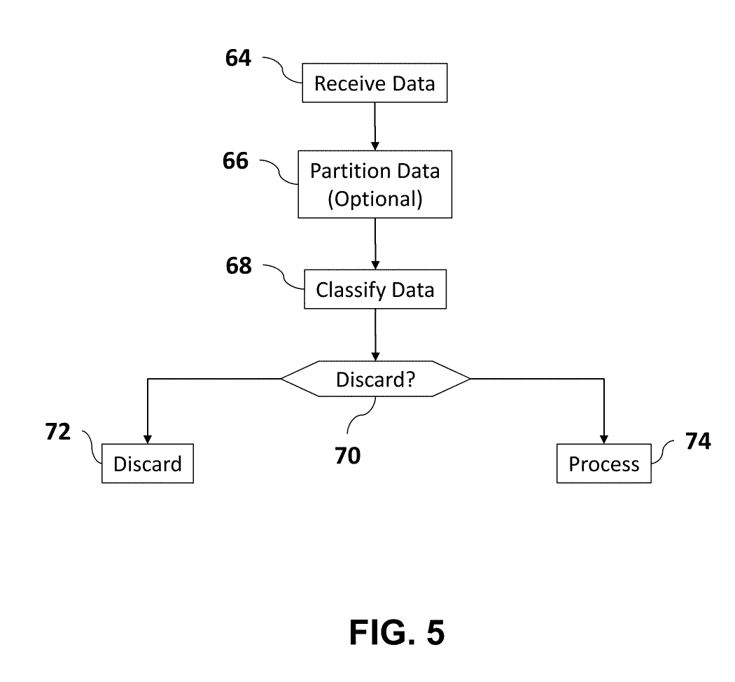

FIG. 5 is another flow diagram of an example process for implementing big data analytics. Data may be received at step 64. Data optionally may be partitioned, as described above, at step 66. Data, or portion thereof, may be classified, as described above, at step 68. At step 70 it may be determined if data, or portion thereof, is to be discarded, based on the classification performed at step 68. If it is determined at step 70 that data, or portion thereof, is to be discarded, the data, or portion thereof, may be discarded at step 72. If it is determined at step 70 that data, or portion thereof, is not to be discarded, the data, or portion thereof, may be processed, as described above, at step 74.

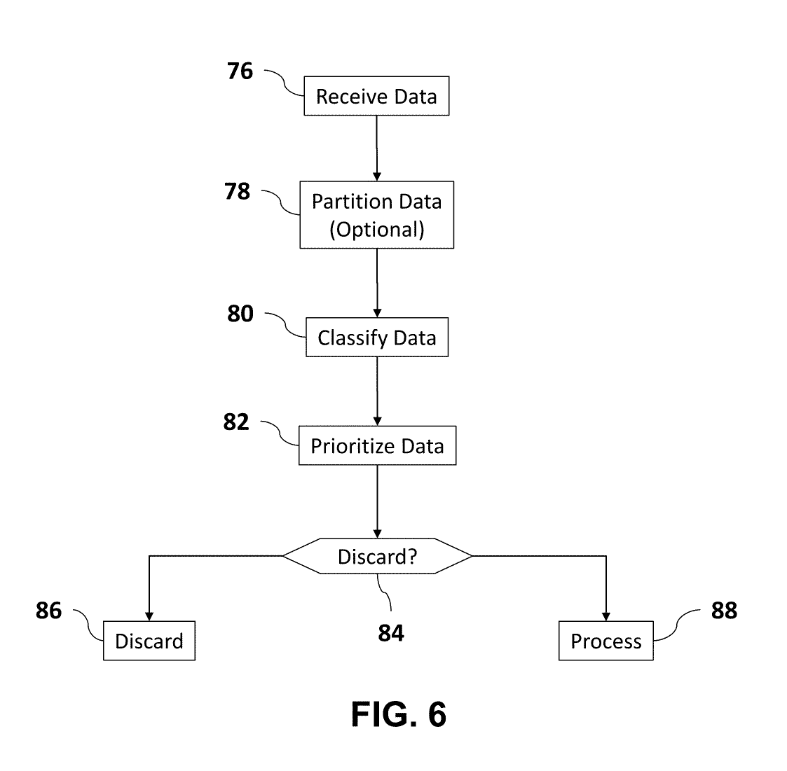

FIG. 6 is another flow diagram of an example process for implementing big data analytics. Data may be received at step 76. Data optionally may be partitioned, as described above, at step 78. Data, or portion thereof, may be classified, as described above, at step 68. Classified data, or portion thereof, may be prioritized, as described above, at step 82. At step 84 it may be determined if data, or portion thereof, is to be discarded, based on the classification performed at step 80 and the prioritization of the classified data at step 82. If it is determined at step 84 that data, or portion thereof, is to be discarded, the data, or portion thereof, may be discarded at step 86. If it is determined at step 84 that data, or portion thereof, is not to be discarded, the data, or portion thereof, may be processed, as described above, at step 88.

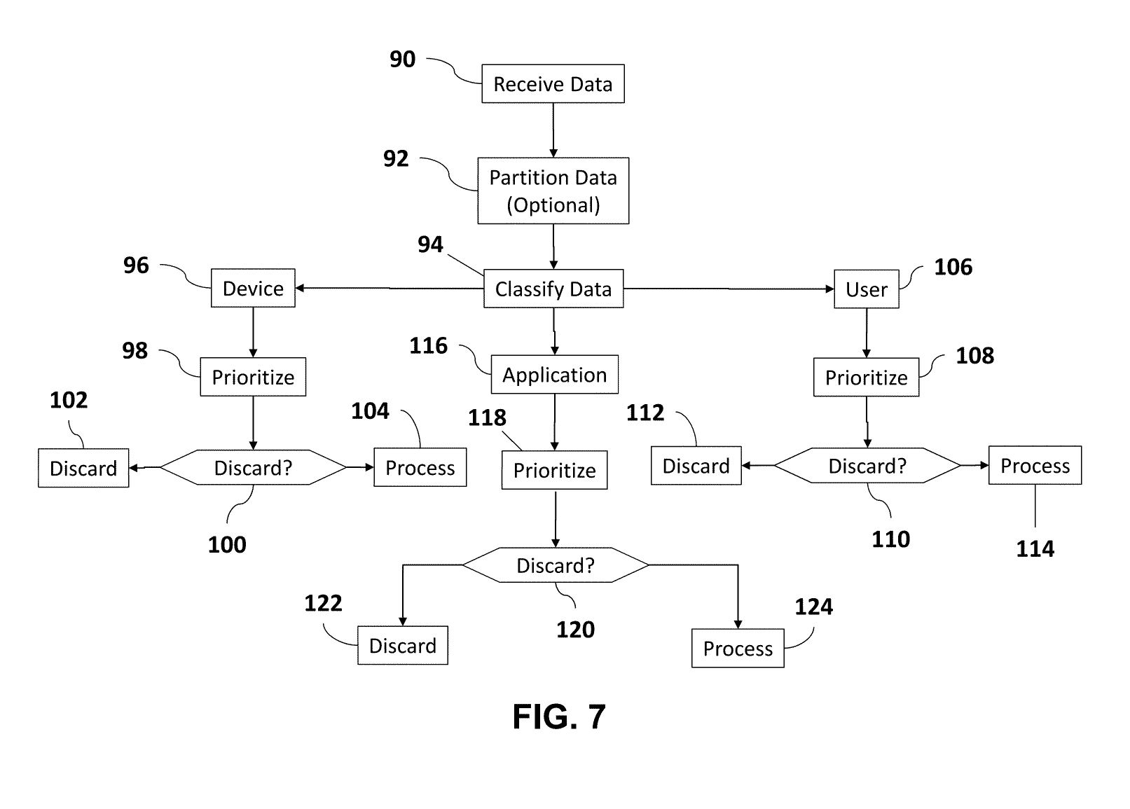

FIG. 7 is another flow diagram of an example process for implementing big data analytics. Data may be received at step 90. Data optionally may be partitioned, as described above, at step 92. Data, or portion thereof, may be classified, as described above, at step 94. In an example embodiment, data may be classified, as described above, as being associated a device (step 96), an application (step 116), a user (step 106), or any appropriate combination thereof.

Data classified as being associated with a device (step 96) may be prioritized, as described above, at step 98. At step 100 it may be determined if data, or portion thereof, is to be discarded, based on the classification performed at step 96 and the prioritization of the classified data at step 98. If it is determined at step 100 that data, or portion thereof, is to be discarded, the data, or portion thereof, may be discarded at step 102. If it is determined at step 100 that data, or portion thereof, is not to be discarded, the data, or portion thereof, may be processed, as described above, at step 104.

Data classified as being associated with a user (step 106) may be prioritized, as described above, at step 108. At step 110 it may be determined if data, or portion thereof, is to be discarded, based on the classification performed at step 106 and the prioritization of the classified data at step 108. If it is determined at step 110 that data, or portion thereof, is to be discarded, the data, or portion thereof, may be discarded at step 112. If it is determined at step 110 that data, or portion thereof, is not to be discarded, the data, or portion thereof, may be processed, as described above, at step 114.

Data classified as being associated with an application (step 116) may be prioritized, as described above, at step 118. At step 120 it may be determined if data, or portion thereof, is to be discarded, based on the classification performed at step 116 and the prioritization of the classified data at step 118. If it is determined at step 120 that data, or portion thereof, is to be discarded, the data, or portion thereof, may be discarded at step 122. If it is determined at step 120 that data, or portion thereof, is not to be discarded, the data, or portion thereof, may be processed, as described above, at step 124.

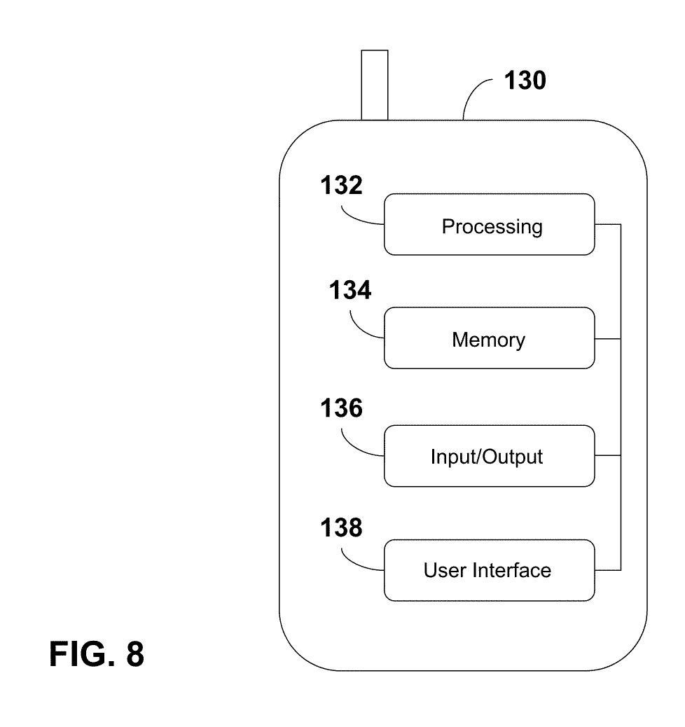

FIG. 8 is a block diagram of an example device 130 that may be utilized to facilitate big data analytics as described herein. The device 130 may comprise and/or be incorporated into any appropriate device, examples of which may include device 12 as depicted in FIG. 1, a mobile device, a mobile communications device, a cellular phone, a portable computing device, such as a laptop, a personal digital assistant (“PDA”), a portable phone (e.g., a cell phone or the like, a smart phone, a video phone), a portable email device, a portable gaming device, a TV, a DVD player, portable media player, (e.g., a portable music player, such as an MP3 player, a Walkman, etc.), a portable navigation device (e.g., GPS compatible device, A-GPS compatible device, etc.), or a combination thereof. The device 130 can include devices that are not typically thought of as portable, such as, for example, a public computing device, a navigation device installed in-vehicle, a set top box, or the like. The mobile device 130 can include non-conventional computing devices, such as, for example, a kitchen appliance, a motor vehicle control (e.g., steering wheel), etc., or the like. As evident from the herein description device 130 is not to be construed as software per se.

The device 130 may include any appropriate device, mechanism, software, and/or hardware for facilitating and/or implementing big data analytics as described herein. In an example embodiment, the ability to facilitate and/or implement big data analytics is a feature of the device 130 that can be turned on and off. Thus, in an example embodiment, an owner and/or user of the device 130 may opt-in or opt-out of this capability.

In an example embodiment, the device 130 may comprise a processor and memory coupled to the processor. The memory may comprise executable instructions that when executed by the processor cause the processor to effectuate operations associated with big data analytics as described herein.

In an example configuration, the device 130 may comprise a processing portion 132, a memory portion 134, an input/output portion 136, and a user interface (UI) portion 138. Each portion of the device 130 comprises circuitry for performing functions associated with each respective portion. Thus, each portion may comprise hardware, or a combination of hardware and software. Accordingly, each portion of the device 130 is not to be construed as software per se. That is, processing portion 132 is not to be construed as software per se. Memory portion 134 is not to be construed as software per se. Input/output portion 136 is not to be construed as software per se. And user interface portion 138 is not to be construed as software per se. Each portion of device 130 may comprise any appropriate configuration of hardware and software as would be ascertainable by those of skill in the art to perform respective functions of big data analytics. It is emphasized that the block diagram depiction of device 130 is exemplary and not intended to imply a specific implementation and/or configuration. For example, in an example configuration, the device 130 may comprise a cellular communications technology and the processing portion 132 and/or the memory portion 134 may be implemented, in part or in total, on a subscriber identity module (SIM) of the device 130. In another example configuration, the device 130 may comprise a laptop computer and/or tablet device (laptop/tablet). The laptop/tablet may include a SIM, and various portions of the processing portion 132 and/or the memory portion 134 may be implemented on the SIM, on the laptop/tablet other than the SIM, or any combination thereof.

The processing portion 132, memory portion 134, and input/output portion 136 may be coupled together to allow communications therebetween. In various embodiments, the input/output portion 136 may comprise a receiver of the device 130, a transmitter of the device 130, or a combination thereof. The input/output portion 136 may be capable of receiving and/or providing information pertaining to big data analytics as described herein In various configurations, the input/output portion 136 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or any appropriate combination thereof.

The processing portion 132 may be capable of performing functions pertaining to big data analytics as described herein. In a basic configuration, the device 130 may include at least one memory portion 134. The memory portion 134 may comprise a storage medium having a concrete, tangible, physical structure. Thus, the memory portion 134, as well as any computer-readable storage medium described herein, is not to be construed as a transient signal per se. Further, the memory portion 134, as well as any computer-readable storage medium described herein, is not to be construed as a propagating signal per se. The memory portion 134, as well as any computer-readable storage medium described herein, is to be construed as an article of manufacture. The memory portion 134 may store any information utilized in conjunction with big data analytics as described herein. Depending upon the exact configuration and type of processor, the memory portion 134 may be volatile (such as some types of RAM), non-volatile (such as ROM, flash memory, etc.), or a combination thereof. The mobile device 130 may include additional storage (e.g., removable storage and/or non-removable storage) such as, for example, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the mobile device 130.

The device 130 also may contain a user interface (UI) portion 138 allowing a user to communicate with the device 130. The UI portion 138 may be capable of rendering any information utilized in conjunction with big data analytics as described herein. The UI portion 138 may provide the ability to control the device 130, via, for example, buttons, soft keys, voice actuated controls, a touch screen, movement of the mobile device 130, visual cues (e.g., moving a hand in front of a camera on the mobile device 130), or the like. The UI portion 138 may provide visual information (e.g., via a display), audio information (e.g., via speaker), mechanically (e.g., via a vibrating mechanism), or a combination thereof. In various configurations, the UI portion 138 may comprise a display, a touch screen, a keyboard, an accelerometer, a motion detector, a speaker, a microphone, a camera, a tilt sensor, or any combination thereof. The UI portion 138 may comprise means for inputting biometric information, such as, for example, fingerprint information, retinal information, voice information, and/or facial characteristic information.

The UI portion 138 may include a display for displaying multimedia such as, for example, application graphical user interfaces (GUIs), text, images, video, telephony functions such as Caller ID data, setup functions, menus, music, metadata, messages, wallpaper, graphics, Internet content, device status, preferences settings, map and location data, routes and other directions, points of interest (POI), and the like.

In some embodiments, the UI portion may comprise a user interface (UI) application. The UI application may interface with a client or operating system (OS) to, for example, facilitate user interaction with device functionality and data. The UI application may aid a user in entering message content, viewing received messages, answering/initiating calls, entering/deleting data, entering and setting user IDs and passwords, configuring settings, manipulating content and/or settings, interacting with other applications, or the like, and may aid the user in inputting selections associated with big data analytics as described herein.

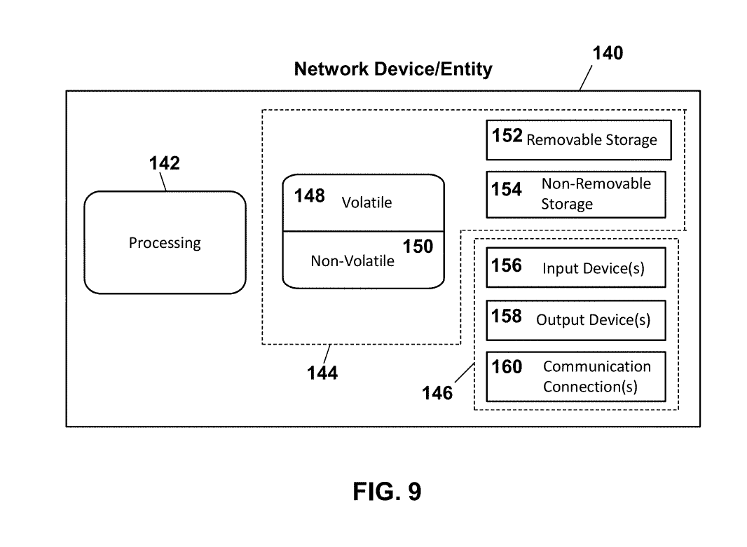

FIG. 9 is a block diagram of an example network device (entity) 140 that may be utilized to implement and/or facilitate big data analytics as described herein. The device 140 may comprise hardware or a combination of hardware and software. In an example embodiment, the device 140 may comprise a network entity and when used in conjunction with a network, the functionality needed to facilitate discovering, negotiating, sharing, and/or exchanging information and/or capabilities as described herein may reside in any one or combination of devices. The device 140 depicted in FIG. 9 may represent any appropriate network entity, or combination of network entities, such as, for example, processor 16 depicted in FIG. 1, processor 18 depicted in FIG. 1, database 20 depicted in FIG. 1, processor 22 depicted in FIG. 1, processor 16 depicted in FIG. 2, processor 18 depicted in FIG. 2, device 30 depicted in FIG. 2, device 32 depicted in FIG. 2, device 34 depicted in FIG. 2, a processor, a server, a gateway, a node, or any appropriate combination thereof. In an example configuration, the device 140 may comprise a component or various components of a cellular broadcast system wireless network. It is emphasized that the block diagram depicted in FIG. 9 is exemplary and not intended to imply a specific implementation or configuration. Thus, the device 140 may be implemented in a single processor or multiple processors (e.g., single server or multiple servers, single gateway or multiple gateways, etc.). Multiple network entities may be distributed or centrally located. Multiple network entities may communicate wirelessly, via hard wire, or any appropriate combination thereof.

In an example embodiment, device 140 may comprise a processor and memory coupled to the processor. The memory may comprise executable instructions that when executed by the processor cause the processor to effectuate operations associated with big data analytics as described herein. As evident from the herein description device 140 is not to be construed as software per se.

In an example configuration, device 140 may comprise a processing portion 142, a memory portion 144, and an input/output portion 146. The processing portion 142, memory portion 144, and input/output portion 146 may be coupled together (coupling not shown in FIG. 9) to allow communications therebetween. Each portion of the device 140 may comprise circuitry for performing functions associated with big data analytics. Thus, each portion may comprise hardware, or a combination of hardware and software. Accordingly, each portion of the device 140 is not to be construed as software per se.

That is, processing portion 142 is not to be construed as software per se. Memory portion 144 is not to be construed as software per se. Input/output portion 146 is not to be construed as software per se. Volatile memory portion 148 is not to be construed as software per se. Non-volatile memory portion 150 is not to be construed as software per se. Removal storage portion 152 is not to be construed as software per se. Non-removal storage portion 154 is not to be construed as software per se. Input device(s) portion 156 is not to be construed as software per se. Input device(s) portion 158 is not to be construed as software per se. And communication connection(s) portion 160 is not to be construed as software per se. Each portion of device 140 may comprise any appropriate configuration of hardware and software as would be ascertainable by those of skill in the art to perform respective functions of big data analytics.

The input/output portion 146 may be capable of receiving and/or providing information from/to a communications device and/or other network entities configured for big data analytics as described herein. For example, the input/output portion 146 may include a wireless communications (e.g., 2.5G/3G/4G/GPS) card. The input/output portion 146 may be capable of receiving and/or sending video information, audio information, control information, image information, data, or any combination thereof. In an example embodiment, the input/output portion 146 may be capable of receiving and/or sending information to determine a location of the device 140 and/or a communications device. In an example configuration, the input\output portion 146 may comprise a GPS receiver. In an example configuration, the device 140 may determine its own geographical location and/or the geographical location of a communications device through any type of location determination system including, for example, the Global Positioning System (GPS), assisted GPS (A-GPS), time difference of arrival calculations, configured constant location (in the case of non-moving devices), any combination thereof, or any other appropriate means. In various configurations, the input/output portion 146 may receive and/or provide information via any appropriate means, such as, for example, optical means (e.g., infrared), electromagnetic means (e.g., RF, WI-FI, BLUETOOTH, ZIGBEE, etc.), acoustic means (e.g., speaker, microphone, ultrasonic receiver, ultrasonic transmitter), or a combination thereof. In an example configuration, the input/output portion may comprise a WIFI finder, a two way GPS chipset or equivalent, or the like, or a combination thereof.

The processing portion 142 may be capable of performing functions associated with big data analytics as described herein. For example, the processing portion 142 may be capable of, in conjunction with any other portion of the device 140, installing an application for big data analytics as described herein.

In a basic configuration, the device 140 may include at least one memory portion 144. The memory portion 144 may comprise a storage medium having a concrete, tangible, physical structure. Thus, the memory portion 144, as well as any computer-readable storage medium described herein, is not to be construed as a transient signal per se. The memory portion 144, as well as any computer-readable storage medium described herein, is not to be construed as a propagating signal per se. The memory portion 144, as well as any computer-readable storage medium described herein, is to be construed as an article of manufacture. The memory portion 144 may store any information utilized in conjunction with big data analytics as described herein. Depending upon the exact configuration and type of processor, the memory portion 144 may be volatile 148 (such as some types of RAM), non-volatile 150 (such as ROM, flash memory, etc.), or a combination thereof. The device 140 may include additional storage (e.g., removable storage 152 and/or non-removable storage 154) such as, for example, tape, flash memory, smart cards, CD-ROM, digital versatile disks (DVD) or other optical storage, magnetic cassettes, magnetic tape, magnetic disk storage or other magnetic storage devices, universal serial bus (USB) compatible memory, or any other medium which can be used to store information and which can be accessed by the device 140.

The device 140 also may contain communications connection(s) 160 that allow the device 140 to communicate with other devices, network entities, or the like. A communications connection(s) may comprise communication media. Communication media may typically embody computer readable instructions, data structures, program modules or other data in a modulated data signal such as a carrier wave or other transport mechanism and includes any information delivery media. By way of example, and not limitation, communication media may include wired media such as a wired network or direct-wired connection, and wireless media such as acoustic, RF, infrared, and other wireless media. The term computer readable media as used herein includes both storage media and communication media. The device 140 also may include input device(s) 156 such as keyboard, mouse, pen, voice input device, touch input device, etc. Output device(s) 158 such as a display, speakers, printer, etc. also may be included.

Big data analytics as described herein may be utilized with various wireless communications networks. Some of which are described below.

FIG. 10 is a diagram of an example communications system in which big data analytics as described herein may be implemented. The communications system 200 may be a multiple access system that provides content, such as voice, data, video, messaging, broadcast, etc., to multiple wireless users. The communications system 200 may enable multiple wireless users to access such content through the sharing of system resources, including wireless bandwidth. For example, the communications systems 200 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like. A communications system such as that shown in FIG. 10 may also be referred to herein as a network.

As shown in FIG. 10, the communications system 200 may include wireless transmit/receive units (WTRUs) 202a, 202b, 202c, 202d, a radio access network (RAN) 204, a core network 206, a public switched telephone network (PSTN) 208, the Internet 210, and other networks 212, though it will be appreciated that the disclosed embodiments contemplate any number of WTRUs, base stations, networks, and/or network elements. Each of the WTRUs 202a, 202b, 202c, 202d may be any type of device configured to operate and/or communicate in a wireless environment. For example, a WTRU may comprise network entity 22, network entity 26, a UE, or the like, or any combination thereof. By way of example, the WTRUs 202a, 202b, 202c, 202d may be configured to transmit and/or receive wireless signals and may include user equipment (UE), a mobile station, a mobile device, a fixed or mobile subscriber unit, a pager, a cellular telephone, a personal digital assistant (PDA), a smartphone, a laptop, a netbook, a personal computer, a wireless sensor, consumer electronics, and the like.

The communications systems 200 may also include a base station 214a and a base station 214b. Each of the base stations 214a, 214b may be any type of device configured to wirelessly interface with at least one of the WTRUs 202a, 202b, 202c, 202d to facilitate access to one or more communication networks, such as the core network 206, the Internet 210, and/or the networks 212. By way of example, the base stations 214a, 214b may be a base transceiver station (BTS), a Node-B, an eNode B, a Home Node B, a Home eNode B, a site controller, an access point (AP), a wireless router, and the like. While the base stations 214a, 214b are each depicted as a single element, it will be appreciated that the base stations 214a, 214b may include any number of interconnected base stations and/or network elements.

The base station 214a may be part of the RAN 204, which may also include other base stations and/or network elements (not shown), such as a base station controller (BSC), a radio network controller (RNC), relay nodes, etc. The base station 214a and/or the base station 214b may be configured to transmit and/or receive wireless signals within a particular geographic region, which may be referred to as a cell (not shown). The cell may further be divided into cell sectors. For example, the cell associated with the base station 214a may be divided into three sectors. Thus, in an embodiment, the base station 214a may include three transceivers, i.e., one for each sector of the cell. In another embodiment, the base station 214a may employ multiple-input multiple output (MIMO) technology and, therefore, may utilize multiple transceivers for each sector of the cell.

The base stations 214a, 214b may communicate with one or more of the WTRUs 202a, 202b, 202c, 202d over an air interface 216, which may be any suitable wireless communication link (e.g., radio frequency (RF), microwave, infrared (IR), ultraviolet (UV), visible light, etc.). The air interface 216 may be established using any suitable radio access technology (RAT).

More specifically, as noted above, the communications system 200 may be a multiple access system and may employ one or more channel access schemes, such as CDMA, TDMA, FDMA, OFDMA, SC-FDMA, and the like. For example, the base station 214a in the RAN 204 and the WTRUs 202a, 202b, 202c may implement a radio technology such as Universal Mobile Telecommunications System (UMTS) Terrestrial Radio Access (UTRA) that may establish the air interface 216 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 214a and the WTRUs 202a, 202b, 202c may implement a radio technology such as Evolved UMTS Terrestrial Radio Access (E-UTRA), which may establish the air interface 216 using Long Term Evolution (LTE) and/or LTE-Advanced (LTE-A).

In other embodiments, the base station 214a and the WTRUs 202a, 202b, 202c may implement radio technologies such as IEEE 802.16 (i.e., Worldwide Interoperability for Microwave Access (WiMAX)), CDMA2000, CDMA2000 2X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 214b in FIG. 10 may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 214b and the WTRUs 202c, 202d may implement a radio technology such as IEEE 802.11 to establish a wireless local area network (WLAN). In another embodiment, the base station 214b and the WTRUs 202c, 202d may implement a radio technology such as IEEE 802.15 to establish a wireless personal area network (WPAN). In yet another embodiment, the base station 214b and the WTRUs 202c, 202d may utilize a cellular-based RAT (e.g., WCDMA, CDMA2000, GSM, LTE, LTE-A, etc.) to establish a picocell or femtocell. As shown in FIG. 10, the base station 214b may have a direct connection to the Internet 210. Thus, the base station 214b may not be required to access the Internet 210 via the core network 206.

The RAN 204 may be in communication with the core network 206, which may be any type of network configured to provide voice, data, applications, and/or voice over internet protocol (VoIP) services to one or more of the WTRUs 202a, 202b, 202c, 202d. For example, the core network 206 may provide call control, billing services, mobile location-based services, pre-paid calling, Internet connectivity, video distribution, etc., and/or perform high-level security functions, such as user authentication. Although not shown in FIG. 10, it will be appreciated that the RAN 204 and/or the core network 206 may be in direct or indirect communication with other RANs that employ the same RAT as the RAN 204 or a different RAT. For example, in addition to being connected to the RAN 204, which may be utilizing an E-UTRA radio technology, the core network 206 may also be in communication with another RAN (not shown) employing a GSM radio technology.

The core network 206 may also serve as a gateway for the WTRUs 202a, 202b, 202c, 202d to access the PSTN 208, the Internet 210, and/or other networks 212. The PSTN 208 may include circuit-switched telephone networks that provide plain old telephone service (POTS). The Internet 210 may include a global system of interconnected computer networks and devices that use common communication protocols, such as the transmission control protocol (TCP), user datagram protocol (UDP) and the internet protocol (IP) in the TCP/IP internet protocol suite. The networks 212 may include wired or wireless communications networks owned and/or operated by other service providers. For example, the networks 212 may include another core network connected to one or more RANs, which may employ the same RAT as the RAN 204 or a different RAT.

Some or all of the WTRUs 202a, 202b, 202c, 202d in the communications system 200 may include multi-mode capabilities, i.e., the WTRUs 202a, 202b, 202c, 202d may include multiple transceivers for communicating with different wireless networks over different wireless links. For example, the WTRU 202c shown in FIG. 10 may be configured to communicate with the base station 214a, which may employ a cellular-based radio technology, and with the base station 214b, which may employ an IEEE 802 radio technology.

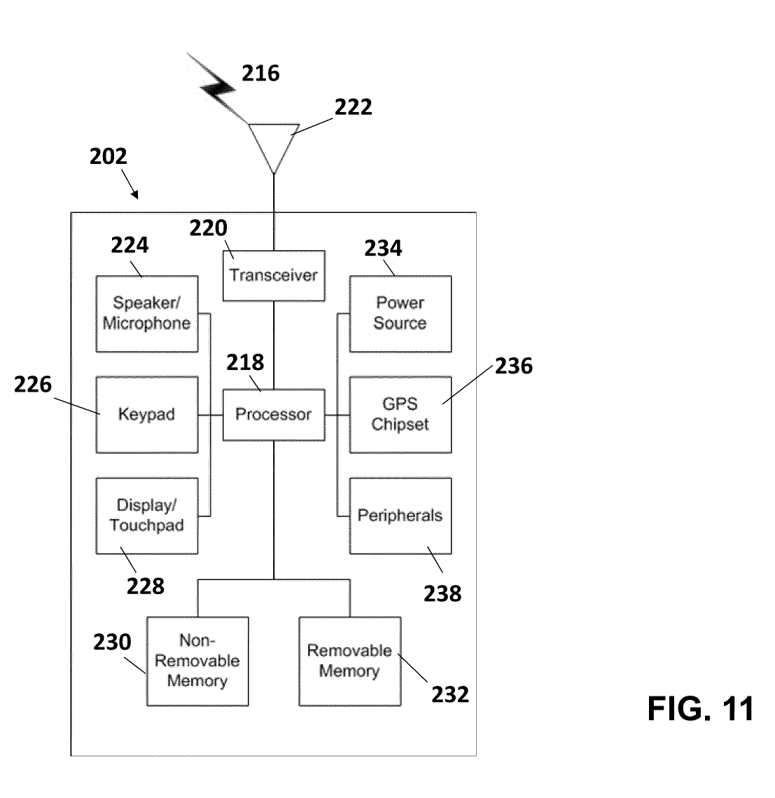

FIG. 11 is a system diagram of an example WTRU 202. As shown in FIG. 11, the WTRU 202 may include a processor 218, a transceiver 220, a transmit/receive element 222, a speaker/microphone 224, a keypad 226, a display/touchpad 228, non-removable memory 230, removable memory 232, a power source 234, a global positioning system (GPS) chipset 236, and other peripherals 238. It will be appreciated that the WTRU 202 may include any sub-combination of the foregoing elements while remaining consistent with an embodiment.

The processor 218 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 218 may perform signal coding, data processing, power control, input/output processing, and/or any other functionality that enables the WTRU 202 to operate in a wireless environment. The processor 218 may be coupled to the transceiver 220, which may be coupled to the transmit/receive element 222. While FIG. 11 depicts the processor 218 and the transceiver 220 as separate components, it will be appreciated that the processor 218 and the transceiver 220 may be integrated together in an electronic package or chip.

The transmit/receive element 222 may be configured to transmit signals to, or receive signals from, a base station (e.g., the base station 214a) over the air interface 216. For example, in one embodiment, the transmit/receive element 222 may be an antenna configured to transmit and/or receive RF signals. In another embodiment, the transmit/receive element 222 may be an emitter/detector configured to transmit and/or receive IR, UV, or visible light signals, for example. In yet another embodiment, the transmit/receive element 222 may be configured to transmit and receive both RF and light signals. It will be appreciated that the transmit/receive element 222 may be configured to transmit and/or receive any combination of wireless signals.

In addition, although the transmit/receive element 222 is depicted in FIG. 11 as a single element, the WTRU 202 may include any number of transmit/receive elements 222. More specifically, the WTRU 202 may employ MIMO technology. Thus, in one embodiment, the WTRU 202 may include two or more transmit/receive elements 222 (e.g., multiple antennas) for transmitting and receiving wireless signals over the air interface 216.

The transceiver 220 may be configured to modulate the signals that are to be transmitted by the transmit/receive element 222 and to demodulate the signals that are received by the transmit/receive element 222. As noted above, the WTRU 202 may have multi-mode capabilities. Thus, the transceiver 220 may include multiple transceivers for enabling the WTRU 202 to communicate via multiple RATs, such as UTRA and IEEE 802.11, for example.

The processor 218 of the WTRU 202 may be coupled to, and may receive user input data from, the speaker/microphone 224, the keypad 226, and/or the display/touchpad 228 (e.g., a liquid crystal display (LCD) display unit or organic light-emitting diode (OLED) display unit). The processor 218 may also output user data to the speaker/microphone 224, the keypad 226, and/or the display/touchpad 228. In addition, the processor 218 may access information from, and store data in, any type of suitable memory, such as the non-removable memory 230 and/or the removable memory 232. The non-removable memory 230 may include random-access memory (RAM), read-only memory (ROM), a hard disk, or any other type of memory storage device. The removable memory 232 may include a subscriber identity module (SIM) card, a memory stick, a secure digital (SD) memory card, and the like. In other embodiments, the processor 218 may access information from, and store data in, memory that is not physically located on the WTRU 202, such as on a server or a home computer (not shown).

The processor 218 may receive power from the power source 234, and may be configured to distribute and/or control the power to the other components in the WTRU 202. The power source 234 may be any suitable device for powering the WTRU 202. For example, the power source 234 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 218 may also be coupled to the GPS chipset 236, which may be configured to provide location information (e.g., longitude and latitude) regarding the current location of the WTRU 202. In addition to, or in lieu of, the information from the GPS chipset 236, the WTRU 202 may receive location information over the air interface 216 from a base station (e.g., base stations 214a, 214b) and/or determine its location based on the timing of the signals being received from two or more nearby base stations. It will be appreciated that the WTRU 202 may acquire location information by way of any suitable location-determination method while remaining consistent with an embodiment.

The processor 218 may further be coupled to other peripherals 238, which may include one or more software and/or hardware modules that provide additional features, functionality and/or wired or wireless connectivity. For example, the peripherals 238 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

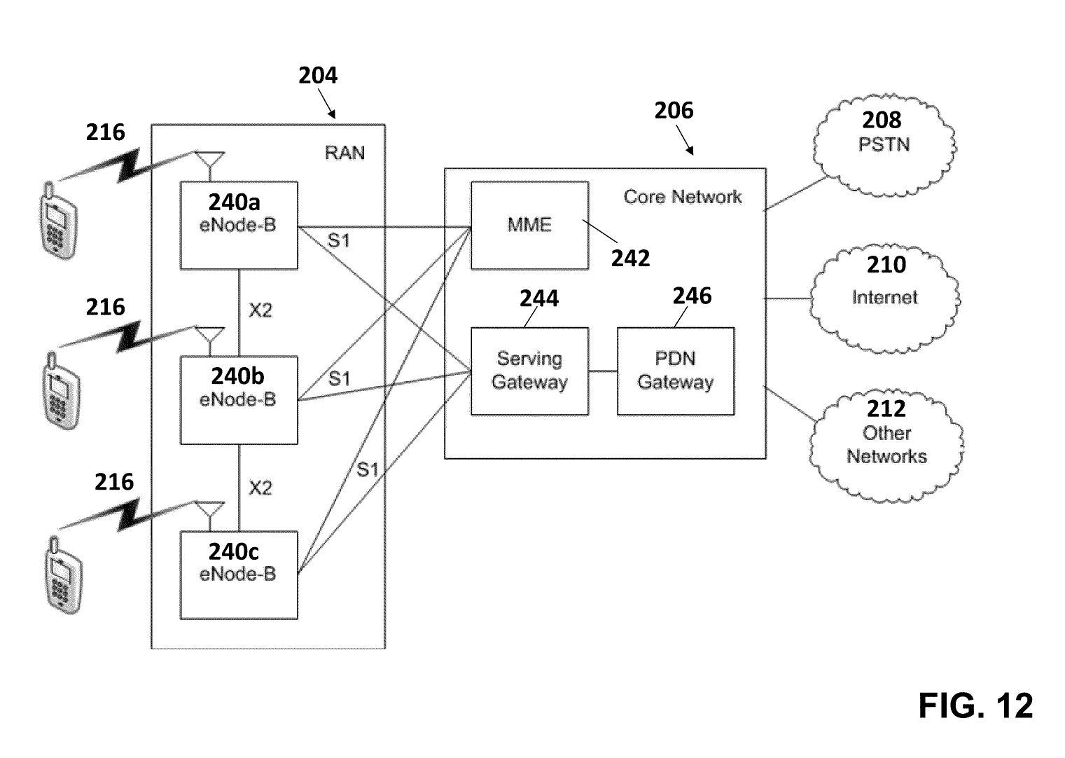

FIG. 12 is an example system diagram of RAN 204 and an core network 206. As noted above, the RAN 204 may employ an E-UTRA radio technology to communicate with the WTRUs 202a, 202b, and 202c over the air interface 216. The RAN 204 may also be in communication with the core network 206.

The RAN 204 may include eNode-Bs 240a, 240b, 240c, though it will be appreciated that the RAN 204 may include any number of eNode-Bs while remaining consistent with an embodiment. The eNode-Bs 240a, 240b, 240c may each include one or more transceivers for communicating with the WTRUs 202a, 202b, 202c over the air interface 216. In one embodiment, the eNode-Bs 240a, 240b, 240c may implement MIMO technology. Thus, the eNode-B 240a, for example, may use multiple antennas to transmit wireless signals to, and receive wireless signals from, the WTRU 202a.

Each of the eNode-Bs 240a, 240b, and 240c may be associated with a particular cell (not shown) and may be configured to handle radio resource management decisions, handover decisions, scheduling of users in the uplink and/or downlink, and the like. As shown in FIG. 12, the eNode-Bs 240a, 240b, 240c may communicate with one another over an X2 interface.

The core network 206 shown in FIG. 12 may include a mobility management gateway or entity (MME) 242, a serving gateway 244, and a packet data network (PDN) gateway 246. While each of the foregoing elements are depicted as part of the core network 206, it will be appreciated that any one of these elements may be owned and/or operated by an entity other than the core network operator.

The MME 242 may be connected to each of the eNode-Bs 240a, 240b, 240c in the RAN 204 via an S1 interface and may serve as a control node. For example, the MME 242 may be responsible for authenticating users of the WTRUs 202a, 202b, 202c, bearer activation/deactivation, selecting a particular serving gateway during an initial attach of the WTRUs 202a, 202b, 202c, and the like. The MME 242 may also provide a control plane function for switching between the RAN 204 and other RANs (not shown) that employ other radio technologies, such as GSM or WCDMA.

The serving gateway 244 may be connected to each of the eNode-Bs 240a, 240b, and 240c in the RAN 204 via the S1 interface. The serving gateway 244 may generally route and forward user data packets to/from the WTRUs 202a, 202b, 202c. The serving gateway 244 may also perform other functions, such as anchoring user planes during inter-eNode B handovers, triggering paging when downlink data is available for the WTRUs 202a, 202b, 202c, managing and storing contexts of the WTRUs 202a, 202b, 202c, and the like.

The serving gateway 244 may also be connected to the PDN gateway 246, which may provide the WTRUs 202a, 202b, 202c with access to packet-switched networks, such as the Internet 210, to facilitate communications between the WTRUs 202a, 202b, 202c and IP-enabled devices.

The core network 206 may facilitate communications with other networks. For example, the core network 206 may provide the WTRUs 202a, 202b, 202c with access to circuit-switched networks, such as the PSTN 208, to facilitate communications between the WTRUs 202a, 202b, 202c and traditional land-line communications devices. For example, the core network 206 may include, or may communicate with, an IP gateway (e.g., an IP multimedia subsystem (IMS) server) that serves as an interface between the core network 206 and the PSTN 208. In addition, the core network 206 may provide the WTRUs 202a, 202b, 202c with access to the networks 212, which may include other wired or wireless networks that are owned and/or operated by other service providers.

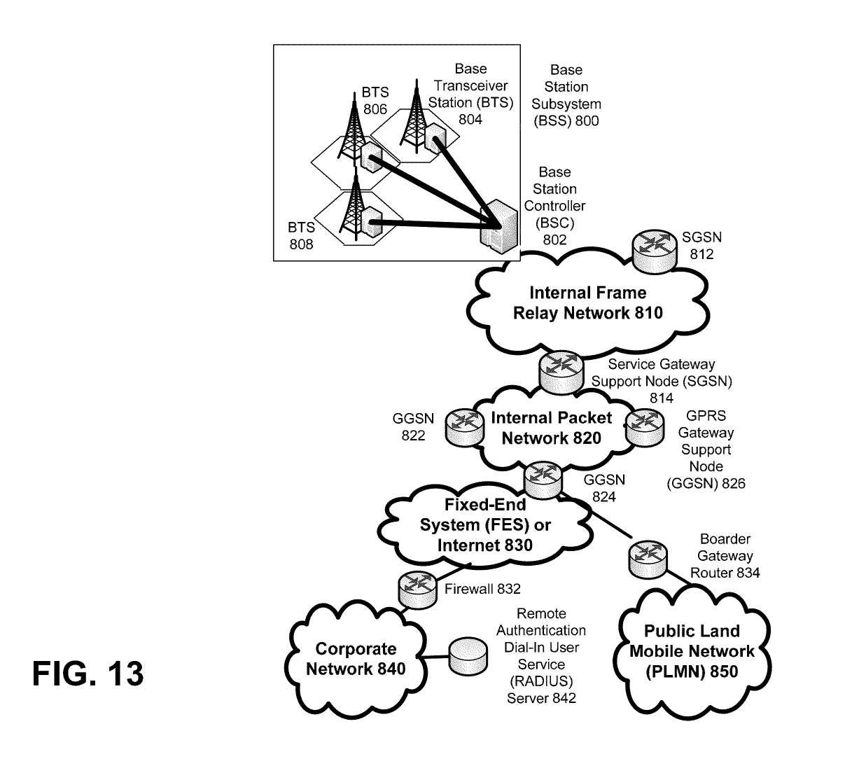

FIG. 13 depicts an overall block diagram of an example packet-based mobile cellular network environment, such as a GPRS network, within which big data analytics as described herein may be implemented. In the example packet-based mobile cellular network environment shown in FIG. 13, there are a plurality of Base Station Subsystems (“BSS”) 800 (only one is shown), each of which comprises a Base Station Controller (“BSC”) 802 serving a plurality of Base Transceiver Stations (“BTS”) such as BTSs 804, 806, and 808. BTSs 804, 806, 808, etc. are the access points where users of packet-based mobile devices become connected to the wireless network. In example fashion, the packet traffic originating from user devices is transported via an over-the-air interface to a BTS 808, and from the BTS 808 to the BSC 802. Base station subsystems, such as BSS 800, are a part of internal frame relay network 810 that can include Service GPRS Support Nodes (“SGSN”) such as SGSN 812 and 814. Each SGSN is connected to an internal packet network 820 through which a SGSN 812, 814, etc. can route data packets to and from a plurality of gateway GPRS support nodes (GGSN) 822, 824, 826, etc. As illustrated, SGSN 814 and GGSNs 822, 824, and 826 are part of internal packet network 820. Gateway GPRS serving nodes 822, 824 and 826 mainly provide an interface to external Internet Protocol (“IP”) networks such as Public Land Mobile Network (“PLMN”) 850, corporate intranets 840, or Fixed-End System (“FES”) or the public Internet 830. As illustrated, subscriber corporate network 840 may be connected to GGSN 824 via firewall 832; and PLMN 850 is connected to GGSN 824 via boarder gateway router 834. The Remote Authentication Dial-In User Service (“RADIUS”) server 842 may be used for caller authentication when a user of a mobile cellular device calls corporate network 840.

Generally, there can be a several cell sizes in a GSM network, referred to as macro, micro, pico, femto and umbrella cells. The coverage area of each cell is different in different environments. Macro cells can be regarded as cells in which the base station antenna is installed in a mast or a building above average roof top level. Micro cells are cells whose antenna height is under average roof top level. Micro-cells are typically used in urban areas. Pico cells are small cells having a diameter of a few dozen meters. Pico cells are used mainly indoors. Femto cells have the same size as pico cells, but a smaller transport capacity. Femto cells are used indoors, in residential, or small business environments. On the other hand, umbrella cells are used to cover shadowed regions of smaller cells and fill in gaps in coverage between those cells.

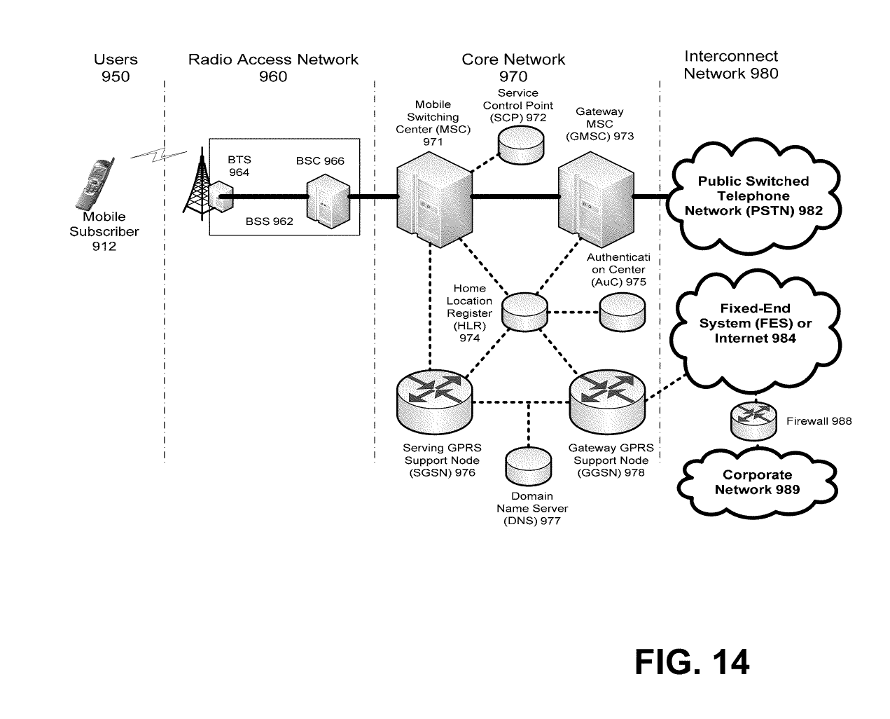

FIG. 14 illustrates an architecture of a typical GPRS network within which big data analytics as described herein may be implemented. The architecture depicted in FIG. 14 is segmented into four groups: users 950, radio access network 960, core network 970, and interconnect network 980. Users 950 comprise a plurality of end users. Note, device 912 is referred to as a mobile subscriber in the description of network shown in FIG. 14. In an example embodiment, the device depicted as mobile subscriber 912 comprises a communications device (e.g., communications device 160). Radio access network 960 comprises a plurality of base station subsystems such as BSSs 962, which include BTSs 964 and BSCs 966. Core network 970 comprises a host of various network elements. As illustrated in FIG. 14, core network 970 may comprise Mobile Switching Center (“MSC”) 971, Service Control Point (“SCP”) 972, gateway MSC 973, SGSN 976, Home Location Register (“HLR”) 974, Authentication Center (“AuC”) 975, Domain Name Server (“DNS”) 977, and GGSN 978. Interconnect network 980 also comprises a host of various networks and other network elements. As illustrated in FIG. 14, interconnect network 980 comprises Public Switched Telephone Network (“PSTN”) 982, Fixed-End System (“FES”) or Internet 984, firewall 988, and Corporate Network 989.

A mobile switching center can be connected to a large number of base station controllers. At MSC 971, for instance, depending on the type of traffic, the traffic may be separated in that voice may be sent to Public Switched Telephone Network (“PSTN”) 982 through Gateway MSC (“GMSC”) 973, and/or data may be sent to SGSN 976, which then sends the data traffic to GGSN 978 for further forwarding.

When MSC 971 receives call traffic, for example, from BSC 966, it sends a query to a database hosted by SCP 972. The SCP 972 processes the request and issues a response to MSC 971 so that it may continue call processing as appropriate.

The HLR 974 is a centralized database for users to register to the GPRS network. HLR 974 stores static information about the subscribers such as the International Mobile Subscriber Identity (“IMSI”), subscribed services, and a key for authenticating the subscriber. HLR 974 also stores dynamic subscriber information such as the current location of the mobile subscriber. Associated with HLR 974 is AuC 975. AuC 975 is a database that contains the algorithms for authenticating subscribers and includes the associated keys for encryption to safeguard the user input for authentication.

In the following, depending on context, the term “mobile subscriber” sometimes refers to the end user and sometimes to the actual portable device, such as a mobile device, used by an end user of the mobile cellular service. When a mobile subscriber turns on his or her mobile device, the mobile device goes through an attach process by which the mobile device attaches to an SGSN of the GPRS network. In FIG. 14, when mobile subscriber 912 initiates the attach process by turning on the network capabilities of the mobile device, an attach request is sent by mobile subscriber 912 to SGSN 976. The SGSN 976 queries another SGSN, to which mobile subscriber 912 was attached before, for the identity of mobile subscriber 912. Upon receiving the identity of mobile subscriber 912 from the other SGSN, SGSN 976 requests more information from mobile subscriber 912. This information is used to authenticate mobile subscriber 912 to SGSN 976 by HLR 974. Once verified, SGSN 976 sends a location update to HLR 974 indicating the change of location to a new SGSN, in this case SGSN 976. HLR 974 notifies the old SGSN, to which mobile subscriber 912 was attached before, to cancel the location process for mobile subscriber 912. HLR 974 then notifies SGSN 976 that the location update has been performed. At this time, SGSN 976 sends an Attach Accept message to mobile subscriber 912, which in turn sends an Attach Complete message to SGSN 976.

After attaching itself with the network, mobile subscriber 912 then goes through the authentication process. In the authentication process, SGSN 976 sends the authentication information to HLR 974, which sends information back to SGSN 976 based on the user profile that was part of the user's initial setup. The SGSN 976 then sends a request for authentication and ciphering to mobile subscriber 912. The mobile subscriber 912 uses an algorithm to send the user identification (ID) and password to SGSN 976. The SGSN 976 uses the same algorithm and compares the result. If a match occurs, SGSN 976 authenticates mobile subscriber 912.

Next, the mobile subscriber 912 establishes a user session with the destination network, corporate network 989, by going through a Packet Data Protocol (“PDP”) activation process. Briefly, in the process, mobile subscriber 912 requests access to the Access Point Name (“APN”), for example, UPS.com, and SGSN 976 receives the activation request from mobile subscriber 912. SGSN 976 then initiates a Domain Name Service (“DNS”) query to learn which GGSN node has access to the UPS.com APN. The DNS query is sent to the DNS server within the core network 970, such as DNS 977, which is provisioned to map to one or more GGSN nodes in the core network 970. Based on the APN, the mapped GGSN 978 can access the requested corporate network 989. The SGSN 976 then sends to GGSN 978 a Create Packet Data Protocol (“PDP”) Context Request message that contains necessary information. The GGSN 978 sends a Create PDP Context Response message to SGSN 976, which then sends an Activate PDP Context Accept message to mobile subscriber 912.

Once activated, data packets of the call made by mobile subscriber 912 can then go through radio access network 960, core network 970, and interconnect network 980, in a particular fixed-end system or Internet 984 and firewall 988, to reach corporate network 989.

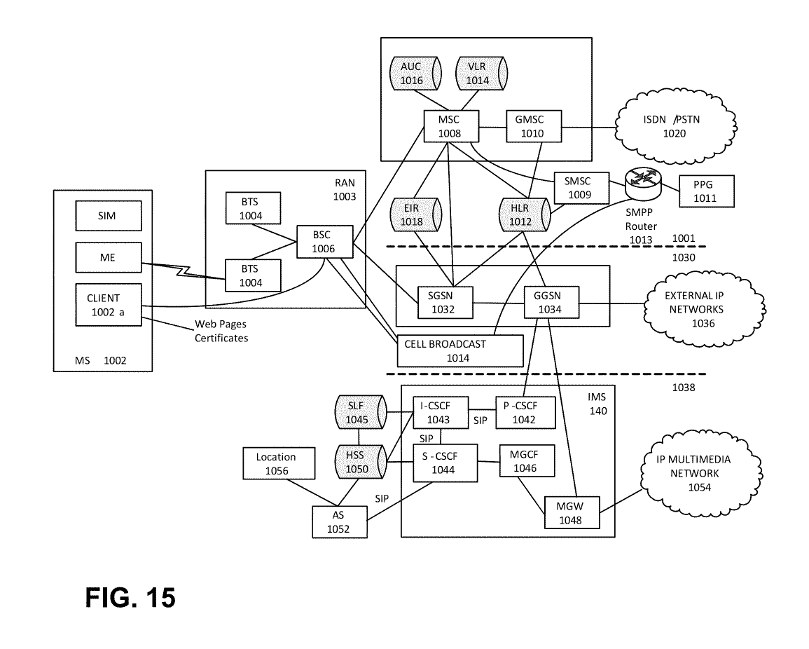

FIG. 15 illustrates an example block diagram view of a GSM/GPRS/IP multimedia network architecture within which big data analytics as described herein may be implemented. As illustrated, the architecture of FIG. 15 includes a GSM core network 1001, a GPRS network 1030 and an IP multimedia network 1038. The GSM core network 1001 includes a Mobile Station (MS) 1002, at least one Base Transceiver Station (BTS) 1004 and a Base Station Controller (BSC) 1006. The MS 1002 is physical equipment or Mobile Equipment (ME), such as a mobile phone or a laptop computer that is used by mobile subscribers, with a Subscriber identity Module (SIM) or a Universal Integrated Circuit Card (UICC). The SIM or UICC includes an International Mobile Subscriber Identity (IMSI), which is a unique identifier of a subscriber. The BTS 1004 is physical equipment, such as a radio tower, that enables a radio interface to communicate with the MS. Each BTS may serve more than one MS. The BSC 1006 manages radio resources, including the BTS. The BSC may be connected to several BTSs. The BSC and BTS components, in combination, are generally referred to as a base station (BSS) or radio access network (RAN) 1003.

The GSM core network 1001 also includes a Mobile Switching Center (MSC) 1008, a Gateway Mobile Switching Center (GMSC) 1010, a Home Location Register (HLR) 1012, Visitor Location Register (VLR) 1014, an Authentication Center (AuC) 1018, and an Equipment Identity Register (EIR) 1016. The MSC 1008 performs a switching function for the network. The MSC also performs other functions, such as registration, authentication, location updating, handovers, and call routing. The GMSC 1010 provides a gateway between the GSM network and other networks, such as an Integrated Services Digital Network (ISDN) or Public Switched Telephone Networks (PSTNs) 1020. Thus, the GMSC 1010 provides interworking functionality with external networks.

The HLR 1012 is a database that contains administrative information regarding each subscriber registered in a corresponding GSM network. The HLR 1012 also contains the current location of each MS. The VLR 1014 is a database that contains selected administrative information from the HLR 1012. The VLR contains information necessary for call control and provision of subscribed services for each MS currently located in a geographical area controlled by the VLR. The HLR 1012 and the VLR 1014, together with the MSC 1008, provide the call routing and roaming capabilities of GSM. The AuC 1016 provides the parameters needed for authentication and encryption functions. Such parameters allow verification of a subscriber's identity. The EIR 1018 stores security-sensitive information about the mobile equipment.

A Short Message Service Center (SMSC) 1009 allows one-to-one Short Message Service (SMS) messages to be sent to/from the MS 1002. A Push Proxy Gateway (PPG) 1011 is used to “push” (i.e., send without a synchronous request) content to the MS 1002. The PPG 1011 acts as a proxy between wired and wireless networks to facilitate pushing of data to the MS 1002. A Short Message Peer to Peer (SMPP) protocol router 1013 is provided to convert SMS-based SMPP messages to cell broadcast messages. SMPP is a protocol for exchanging SMS messages between SMS peer entities such as short message service centers. The SMPP protocol is often used to allow third parties, e.g., content suppliers such as news organizations, to submit bulk messages.

To gain access to GSM services, such as speech, data, and short message service (SMS), the MS first registers with the network to indicate its current location by performing a location update and IMSI attach procedure. The MS 1002 sends a location update including its current location information to the MSC/VLR, via the BTS 1004 and the BSC 1006. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 1030 is logically implemented on the GSM core network architecture by introducing two packet-switching network nodes, a serving GPRS support node (SGSN) 1032, a cell broadcast and a Gateway GPRS support node (GGSN) 1034. The SGSN 1032 is at the same hierarchical level as the MSC 1008 in the GSM network. The SGSN controls the connection between the GPRS network and the MS 1002. The SGSN also keeps track of individual MS's locations and security functions and access controls.

A Cell Broadcast Center (CBC) 14 communicates cell broadcast messages that are typically delivered to multiple users in a specified area. Cell Broadcast is one-to-many geographically focused service. It enables messages to be communicated to multiple mobile phone customers who are located within a given part of its network coverage area at the time the message is broadcast.

The GGSN 1034 provides a gateway between the GPRS network and a public packet network (PDN) or other IP networks 1036. That is, the GGSN provides interworking functionality with external networks, and sets up a logical link to the MS through the SGSN. When packet-switched data leaves the GPRS network, it is transferred to an external TCP-IP network 1036, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, and the GGSN.

In a GSM/GPRS network, GPRS services and GSM services can be used in parallel. The MS can operate in one of three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 1030 can be designed to operate in three network operation modes (NOM1, NOM2 and NOM3). A network operation mode of a GPRS network is indicated by a parameter in system information messages transmitted within a cell. The system information messages dictates a MS where to listen for paging messages and how to signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not receive pages from a circuit switched domain when engaged in a data call, since the MS is receiving data and is not listening to a paging channel. In a NOM3 network, a MS can monitor pages for a circuit switched network while received data and vice versa.

The IP multimedia network 1038 was introduced with 3GPP Release 5, and includes an IP multimedia subsystem (IMS) 1040 to provide rich multimedia services to end users. A representative set of the network entities within the IMS 1040 are a call/session control function (CSCF), a media gateway control function (MGCF) 1046, a media gateway (MGW) 1048, and a master subscriber database, called a home subscriber server (HSS) 1050. The HSS 1050 may be common to the GSM network 1001, the GPRS network 1030 as well as the IP multimedia network 1038.

The IP multimedia system 1040 is built around the call/session control function, of which there are three types: an interrogating CSCF (I-CSCF) 1043, a proxy CSCF (P-CSCF) 1042, and a serving CSCF (S-CSCF) 1044. The P-CSCF 1042 is the MS's first point of contact with the IMS 1040. The P-CSCF 1042 forwards session initiation protocol (SIP) messages received from the MS to an SIP server in a home network (and vice versa) of the MS. The P-CSCF 1042 may also modify an outgoing request according to a set of rules defined by the network operator (for example, address analysis and potential modification).

The I-CSCF 1043, forms an entrance to a home network and hides the inner topology of the home network from other networks and provides flexibility for selecting an S-CSCF. The I-CSCF 1043 may contact a subscriber location function (SLF) 1045 to determine which HSS 1050 to use for the particular subscriber, if multiple HSS's 1050 are present. The S-CSCF 1044 performs the session control services for the MS 1002. This includes routing originating sessions to external networks and routing terminating sessions to visited networks. The S-CSCF 1044 also decides whether an application server (AS) 1052 is required to receive information on an incoming SIP session request to ensure appropriate service handling. This decision is based on information received from the HSS 1050 (or other sources, such as an application server 1052). The AS 1052 also communicates to a location server 1056 (e.g., a Gateway Mobile Location Center (GMLC)) that provides a position (e.g., latitude/longitude coordinates) of the MS 1002.

The HSS 1050 contains a subscriber profile and keeps track of which core network node is currently handling the subscriber. It also supports subscriber authentication and authorization functions (AAA). In networks with more than one HSS 1050, a subscriber location function provides information on the HSS 1050 that contains the profile of a given subscriber.

The MGCF 1046 provides interworking functionality between SIP session control signaling from the IMS 1040 and ISUP/BICC call control signaling from the external GSTN networks (not shown). It also controls the media gateway (MGW) 1048 that provides user-plane interworking functionality (e.g., converting between AMR- and PCM-coded voice). The MGW 1048 also communicates with other IP multimedia networks 1054.

Push to Talk over Cellular (PoC) capable mobile phones register with the wireless network when the phones are in a predefined area (e.g., job site, etc.). When the mobile phones leave the area, they register with the network in their new location as being outside the predefined area. This registration, however, does not indicate the actual physical location of the mobile phones outside the pre-defined area.

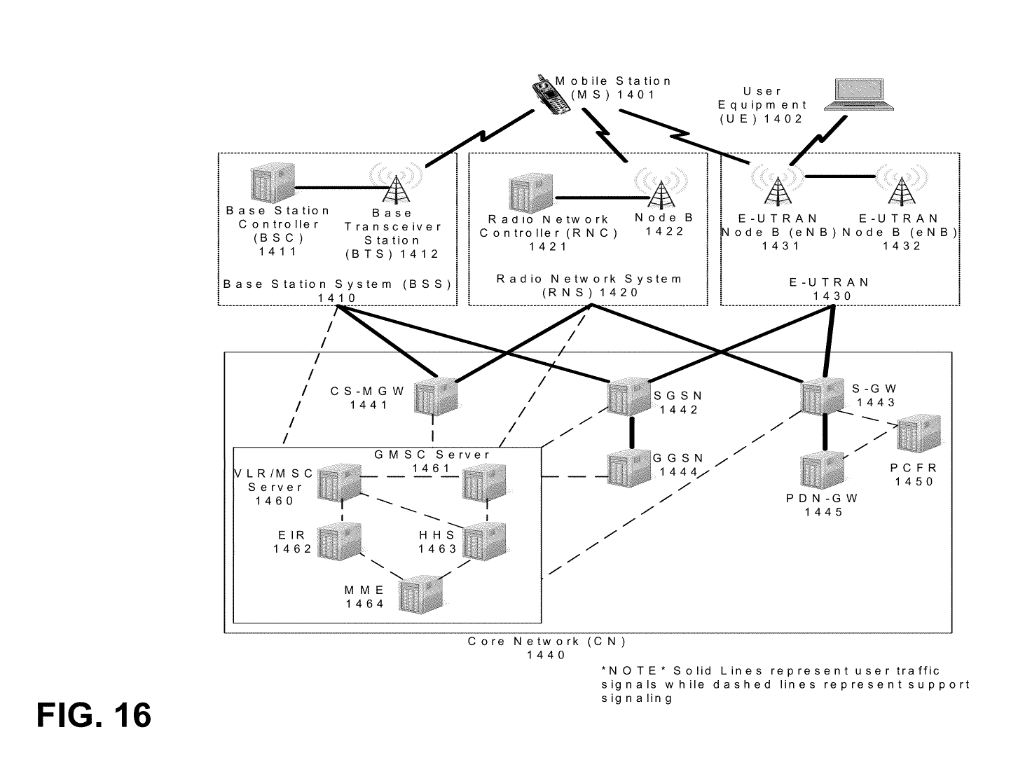

FIG. 16 illustrates a PLMN block diagram view of an example architecture in which big data analytics as described herein may be implemented. Mobile Station (MS) 1401 is the physical equipment used by the PLMN subscriber. In one illustrative embodiment, communications device 200 may serve as Mobile Station 1401. Mobile Station 1401 may be one of, but not limited to, a cellular telephone, a cellular telephone in combination with another electronic device or any other wireless mobile communication device.

Mobile Station 1401 may communicate wirelessly with Base Station System (BSS) 1410. BSS 1410 contains a Base Station Controller (BSC) 1411 and a Base Transceiver Station (BTS) 1412. BSS 1410 may include a single BSC 1411/BTS 1412 pair (Base Station) or a system of BSC/BTS pairs which are part of a larger network. BSS 1410 is responsible for communicating with Mobile Station 1401 and may support one or more cells. BSS 1410 is responsible for handling cellular traffic and signaling between Mobile Station 1401 and Core Network 1440. Typically, BSS 1410 performs functions that include, but are not limited to, digital conversion of speech channels, allocation of channels to mobile devices, paging, and transmission/reception of cellular signals.

Additionally, Mobile Station 1401 may communicate wirelessly with Radio Network System (RNS) 1420. RNS 1420 contains a Radio Network Controller (RNC) 1421 and one or more Node(s) B 1422. RNS 1420 may support one or more cells. RNS 1420 may also include one or more RNC 1421/Node B 1422 pairs or alternatively a single RNC 1421 may manage multiple Nodes B 1422. RNS 1420 is responsible for communicating with Mobile Station 1401 in its geographically defined area. RNC 1421 is responsible for controlling the Node(s) B 1422 that are connected to it and is a control element in a UMTS radio access network. RNC 1421 performs functions such as, but not limited to, load control, packet scheduling, handover control, security functions, as well as controlling Mobile Station 1401's access to the Core Network (CN) 1440.

The evolved UMTS Terrestrial Radio Access Network (E-UTRAN) 1430 is a radio access network that provides wireless data communications for Mobile Station 1401 and User Equipment 1402. E-UTRAN 1430 provides higher data rates than traditional UMTS. It is part of the Long Term Evolution (LTE) upgrade for mobile networks and later releases meet the requirements of the International Mobile Telecommunications (IMT) Advanced and are commonly known as a 4G networks. E-UTRAN 1430 may include of series of logical network components such as E-UTRAN Node B (eNB) 1431 and E-UTRAN Node B (eNB) 1432. E-UTRAN 1430 may contain one or more eNBs. User Equipment 1402 may be any user device capable of connecting to E-UTRAN 1430 including, but not limited to, a personal computer, laptop, mobile device, wireless router, or other device capable of wireless connectivity to E-UTRAN 1430. The improved performance of the E-UTRAN 1430 relative to a typical UMTS network allows for increased bandwidth, spectral efficiency, and functionality including, but not limited to, voice, high-speed applications, large data transfer and IPTV, while still allowing for full mobility.

An example embodiment of a mobile data and communication service that may be implemented in the PLMN architecture described in FIG. 16 is the Enhanced Data rates for GSM Evolution (EDGE). EDGE is an enhancement for GPRS networks that implements an improved signal modulation scheme known as 8-PSK (Phase Shift Keying). By increasing network utilization, EDGE may achieve up to three times faster data rates as compared to a typical GPRS network. EDGE may be implemented on any GSM network capable of hosting a GPRS network, making it an ideal upgrade over GPRS since it may provide increased functionality of existing network resources. Evolved EDGE networks are becoming standardized in later releases of the radio telecommunication standards, which provide for even greater efficiency and peak data rates of up to 1 Mbit/s, while still allowing implementation on existing GPRS-capable network infrastructure.

Typically Mobile Station 1401 may communicate with any or all of BSS 1410, RNS 1420, or E-UTRAN 1430. In a illustrative system, each of BSS 1410, RNS 1420, and E-UTRAN 1430 may provide Mobile Station 1401 with access to Core Network 1440. The Core Network 1440 may include of a series of devices that route data and communications between end users. Core Network 1440 may provide network service functions to users in the Circuit Switched (CS) domain, the Packet Switched (PS) domain or both. The CS domain refers to connections in which dedicated network resources are allocated at the time of connection establishment and then released when the connection is terminated. The PS domain refers to communications and data transfers that make use of autonomous groupings of bits called packets. Each packet may be routed, manipulated, processed or handled independently of all other packets in the PS domain and does not require dedicated network resources.

The Circuit Switched—Media Gateway Function (CS-MGW) 1441 is part of Core Network 1440, and interacts with Visitor Location Register (VLR) and Mobile-Services Switching Center (MSC) Server 1460 and Gateway MSC Server 1461 in order to facilitate Core Network 1440 resource control in the CS domain. Functions of CS-MGW 1441 include, but are not limited to, media conversion, bearer control, payload processing and other mobile network processing such as handover or anchoring. CS-MGW 1440 may receive connections to Mobile Station 1401 through BSS 1410, RNS 1420 or both.

Serving GPRS Support Node (SGSN) 1442 stores subscriber data regarding Mobile Station 1401 in order to facilitate network functionality. SGSN 1442 may store subscription information such as, but not limited to, the International Mobile Subscriber Identity (IMSI), temporary identities, or Packet Data Protocol (PDP) addresses. SGSN 1442 may also store location information such as, but not limited to, the Gateway GPRS Support Node (GGSN) 1444 address for each GGSN where an active PDP exists. GGSN 1444 may implement a location register function to store subscriber data it receives from SGSN 1442 such as subscription or location information.

Serving Gateway (S-GW) 1443 is an interface which provides connectivity between E-UTRAN 1430 and Core Network 1440. Functions of S-GW 1443 include, but are not limited to, packet routing, packet forwarding, transport level packet processing, event reporting to Policy and Charging Rules Function (PCRF) 1450, and mobility anchoring for inter-network mobility. PCRF 1450 uses information gathered from S-GW 1443, as well as other sources, to make applicable policy and charging decisions related to data flows, network resources and other network administration functions. Packet Data Network Gateway (PDN-GW) 1445 may provide user-to-services connectivity functionality including, but not limited to, network-wide mobility anchoring, bearer session anchoring and control, and IP address allocation for PS domain connections.

Home Subscriber Server (HSS) 1463 is a database for user information, and stores subscription data regarding Mobile Station 1401 or User Equipment 1402 for handling calls or data sessions. Networks may contain one HSS 1463 or more if additional resources are required. Example data stored by HSS 1463 include, but is not limited to, user identification, numbering and addressing information, security information, or location information. HSS 1463 may also provide call or session establishment procedures in both the PS and CS domains.

The VLR/MSC Server 1460 provides user location functionality. When Mobile Station 1401 enters a new network location, it begins a registration procedure. A MSC Server for that location transfers the location information to the VLR for the area. A VLR and MSC Server may be located in the same computing environment, as is shown by VLR/MSC Server 1460, or alternatively may be located in separate computing environments. A VLR may contain, but is not limited to, user information such as the IMSI, the Temporary Mobile Station Identity (TMSI), the Local Mobile Station Identity (LMSI), the last known location of the mobile station, or the SGSN where the mobile station was previously registered. The MSC server may contain information such as, but not limited to, procedures for Mobile Station 1401 registration or procedures for handover of Mobile Station 1401 to a different section of the Core Network 1440. GMSC Server 1461 may serve as a connection to alternate GMSC Servers for other mobile stations in larger networks.

Equipment Identity Register (EIR) 1462 is a logical element which may store the International Mobile Equipment Identities (IMEI) for Mobile Station 1401. In a typical embodiment, user equipment may be classified as either “white listed” or “black listed” depending on its status in the network. In one embodiment, if Mobile Station 1401 is stolen and put to use by an unauthorized user, it may be registered as “black listed” in EIR 1462, preventing its use on the network. Mobility Management Entity (MME) 1464 is a control node which may track Mobile Station 1401 or User Equipment 1402 if the devices are idle. Additional functionality may include the ability of MME 1464 to contact an idle Mobile Station 1401 or User Equipment 1402 if retransmission of a previous session is required.

While example embodiments of big data analytics have been described in connection with various computing devices/processors, the underlying concepts may be applied to any computing device, processor, or system capable of implementing/utilizing big data analytics. The various techniques described herein can be implemented in connection with hardware or software or, where appropriate, with a combination of both. Thus, the methods and apparatuses of using and implementing big data analytics may be implemented, or certain aspects or portions thereof, can take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a transient signal per se. A computer-readable storage medium is not a propagating signal per se. A computer-readable storage medium as described herein is an article of manufacture. When the program code is loaded into and executed by a machine, such as a computer, the machine becomes an apparatus for implementing big data analytics as described herein. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. The language can be a compiled or interpreted language, and combined with hardware implementations.

The methods and apparatuses for using and implementing big data analytics as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for implementing big data analytics as described herein. When implemented on a general-purpose processor, the program code combines with the processor to provide a unique apparatus that operates to invoke the functionality of big data analytics as described herein.

While big data analytics has been described in connection with the various embodiments of the various figures, it is to be understood that other similar embodiments may be used or modifications and additions may be made to the described embodiments of big data analytics without deviating therefrom. For example, one skilled in the art will recognize that big data analytics as described in the instant application may apply to any environment, whether wired or wireless, and may be applied to any number of such devices connected via a communications network and interacting across the network. Therefore, big data analytics as described herein should not be limited to any single embodiment, but rather should be construed in breadth and scope in accordance with the appended claims.

What is claimed:

1. An apparatus comprising:
a processor; and
memory coupled to the processor, the memory comprising executable instructions that when executed by the processor cause the processor to effectuate operations comprising:
processing data, as the data is received, to determine at least one of:
a user identifier associated with a portion of the data;
an application associated with a portion of the data; or
a device associated with a portion of the data;
for each portion of the data associated with a same user identifier, determining whether to further process each portion of the data associated with the same user identifier;
for each portion of the data associated with a same application, determining whether to further process each portion of the data associated with the same application; and
for each portion of the data associated with a same device, determining whether to further process each portion of the data associated with the same device.

2. The apparatus of claim 1, the operations further comprising:
for each portion of data for which further processing is determined:
prioritizing the each portion of the data;
directing processing of the each portion of the data; or
classifying the each portion of the data.

3. The apparatus of claim 2, the operations further comprising:
subsequent to the prioritizing, sequentially processing the each portion of the prioritized data in priority order, wherein prioritizing is based on at least one of:
the user identifier associated with the each portion of the data;
the application associated with the each portion of the data; or
the device associated with the each portion of the data.

4. The apparatus of claim 3, wherein sequentially processing each portion comprises, based on a priority of each portion of the data, one of:
storing the each portion of the data; or
further processing the each portion of the data.

5. The apparatus of claim 2, the operations further comprising:
directing processing of the each portion of the data to one of a plurality of processing functions based at least on:
a value assigned to the device associated with the portion of the data;
a value of the application associated with the portion of the data; or
a value of the user identifier associated with the portion of the data.

6. The apparatus of claim 2, the operations further comprising:
classifying the each portion of the data based at least on:
the device associated with the portion of the data;
the application associated with the portion of the data; or
the user identifier associated with the portion of the data.

7. The apparatus of claim 1, the operations further comprising:
when it is determined to further process each portion of the data, performing one of:
storing the each portion of the data;
discarding the each portion of the data; or
subsequently processing the each portion of the data.

8. A method comprising:
processing data, as the data is received, to determine at least one of:
a user identifier associated with a portion of the data;
an application associated with a portion of the data; or
a device associated with a portion of the data;
for each portion of the data associated with a same user identifier, determining whether to further process each portion of the data associated with the same user identifier;
for each portion of the data associated with a same application, determining whether to further process each portion of the data associated with the same application; and
for each portion of the data associated with a same device, determining whether to further process each portion of the data associated with the same device.

9. The method of claim 8, the operations further comprising:
for each portion of data for which further processing is determined:
prioritizing the each portion of the data;
directing processing of the each portion of the data; or
classifying the each portion of the data.

10. The method of claim 9, the operations further comprising:
subsequent to the prioritizing, sequentially processing the each portion of the prioritized data in priority order, wherein prioritizing is based on at least one of:
the user identifier associated with the each portion of the data;
the application associated with the each portion of the data; or
the device associated with the each portion of the data.

11. The method of claim 10, wherein sequentially processing each portion comprises, based on a priority of each portion of the data, one of:
storing the each portion of the data; or
further processing the each portion of the data.

12. The method of claim 9, the operations further comprising:
directing processing of the each portion of the data to one of a plurality of processing functions based at least on:
a value assigned to the device associated with the portion of the data;
a value of the application associated with the portion of the data; or
a value of the user identifier associated with the portion of the data.

13. The method of claim 9, the operations further comprising:
classifying the each portion of the data based at least on:
the device associated with the portion of the data;
the application associated with the portion of the data; or
the user identifier associated with the portion of the data.

14. The method of claim 8, the operations further comprising:
when it is determined to further process each portion of the data, performing one of:
storing the each portion of the data;
discarding the each portion of the data; or
subsequently processing the each portion of the data.

15. A computer-readable storage medium comprising executable instructions that when executed by a processor cause the processor to effectuate operations comprising:
processing data, as the data is received, to determine at least one of:
a user identifier associated with a portion of the data;
an application associated with a portion of the data; or
a device associated with a portion of the data;
for each portion of the data associated with a same user identifier, determining whether to further process each portion of the data associated with the same user identifier;
for each portion of the data associated with a same application, determining whether to further process each portion of the data associated with the same application; and
for each portion of the data associated with a same device, determining whether to further process each portion of the data associated with the same device.

16. The computer-readable storage medium of claim 15, the operations further comprising:
for each portion of data for which further processing is determined:
prioritizing the each portion of the data;
directing processing of the each portion of the data; or
classifying the each portion of the data.

17. The computer-readable storage medium of claim 16, the operations further comprising:
subsequent to the prioritizing, sequentially processing the each portion of the prioritized data in priority order, wherein prioritizing is based on at least one of:
the user identifier associated with the each portion of the data;
the application associated with the each portion of the data; or
the device associated with the each portion of the data.

18. The computer-readable storage medium of claim 17, wherein sequentially processing each portion comprises, based on a priority of each portion of the data, one of:
storing the each portion of the data; or
further processing the each portion of the data.

19. The computer-readable storage medium of claim 16, the operations further comprising:
directing processing of the each portion of the data to one of a plurality of processing functions based at least on:
a value assigned to the device associated with the portion of the data;
a value of the application associated with the portion of the data; or
a value of the user identifier associated with the portion of the data.

20. The computer-readable storage medium of claim 16, the operations further comprising:
classifying the each portion of the data based at least on:
the device associated with the portion of the data;
the application associated with the portion of the data; or
the user identifier associated with the portion of the data.
